(19) United States
(12) Patent Application Publication
(10) Pub. No.: US 2018/0203338 A1
(43) Pub. Date: Jul. 19, 2018

(54) Illumination Device, Illumination Method, and Video Projection Apparatus Using the Same

(71) Applicant: Hitachi Chemical Company, Ltd., Chiyoda-ku, Tokyo (JP)

(72) Inventors: Tomoto KAWAMURA, Tokyo (JP); Seiji MURATA, Tokyo (JP); Ryuji UKAI, Tokyo (JP); Toshiyuki TAKAIWA, Tokyo (JP); Toshihiro KURODA, Tokyo (JP); Daichi SAKAI, Tokyo (JP); Yutaka KAWAKAMI, Tokyo (JP); Toshiteru NAKAMURA, Tokyo (JP)

(73) Assignee: Hitachi Chemical Company ,Ltd.

(21) Appl. No.: 15/742,689

(22) PCT Filed: Dec. 11, 2015
(86) PCT No.: PCT/JP2015/084741

§ 371 Date: Jan. 8, 2018

(30) Foreign Application Priority Data
Jul. 22, 2015 (JP) 2015-144916

(51) Int. Cl. G03B 21/20; G02B 27/28; G03B 21/28

(52) U.S. Cl. CPC G03B 21/208; G03B 21/28; G02B 27/283; G03B 21/2073

(57) ABSTRACT

To provide an illumination device having high efficiency, an illumination method, a video projection apparatus using the same. In order to achieve the object, there is provided an illumination device configured to include a light source and a light condensing body which condenses light from the light source to be emitted, and the light condensing body includes an incidence surface of a light source side, an emission surface emitting light, and a side surface which is present between the incidence surface and the emission surface, the side surface is a curved surface of which a distance from a light axis in a direction orthogonal to the light emitting surface of the light source at the center of the light source becomes large from the incidence surface toward the emission surface and has a plurality of curved-surface-shapes of which shapes of the curved surfaces are different from each other. There is provided an illumination device configured to include a light source, a light integrator homogenizing light emitted from the light source through total internal reflection and filled with a transparent material, a lens converting light emitted from the light integrator into substantially parallel light, and a reflection parabolic surface converting light emitted from the light integrator into substantially parallel light and disposed on the outside of the lens, and a surface of the light integrator side of the lens is disposed on a side closer to a light integrator side than an end in the light axis direction of the lens which is located at a side opposite to the light integrator of the reflection parabolic surface.

### TECHNICAL FIELD

The present invention relates to an illumination device for illuminating light on a predetermined region, an illumination method, and a video projection apparatus using the same.

### BACKGROUND ART

In an lighting fixture using a surface-emitting (LED, OLED) light source, or a video projection apparatus such as a projector and a head mounted display, an illumination device that efficiently transmits light from a light source to a desired region is required. From the viewpoint of power consumption, transmission efficiency of light is an important factor in the illumination device.

As the background art of the technical field of the invention, regarding an illumination device, in JP-A-2011-165351 (PTL 1) and JP-A-2012-145904 (PTL 2), an illumination device for an lighting fixture in which a light condensing body (lens) having a lens function for light of an inner side with respect to the center of a light axis and having a reflector function for light in an outside in order to emit light from an LED to the outside is used is described.

Regarding a video projection apparatus, in JP-A-2004-258666 (PTL 3), as the illumination device for use in the projector, an example in which light from a lamp is condensed in a reflector and light emitted from the light pipe is illuminated on a display device, which generates video, by a lens using the light pipe for improving homogeneity is disclosed.

### CITATION LIST

### Patent Literature

PTL 1: JP-A-2011-165351

PTL 2: JP-A-2012-145904

PTL 3: JP-A-2004-258666

### SUMMARY OF INVENTION

### Technical Problem

In recent years, the development of a video projection apparatus, which is represented by a head mounted display (hereinafter, denoted by HMD) or a head-up display (hereinafter, denoted by HUD), projecting a virtual image is being progressed. The virtual image is video for causing video to be formed on an ocular fundus using a lens function of the human eye. In an optical system projecting the virtual image, a capturing angle of light is limited by the human pupils and an aperture of an emission surface of the video projection apparatus. When the aperture of the emission surface is made large, the video projection apparatus becomes too large and thus, the video projection apparatus projecting the virtual image is usually made small and thus, the capturing angle of light becomes small.

In the meantime, since the capturing angle of light of the conventional illumination device is large, an apparatus becomes larger and is not suitable for use as the video projection apparatus projecting the virtual image. That is, the lighting fixture illuminates a wide range of a room and thus, the capturing angle of light is large. Accordingly, the illumination device of PTL 1 and PTL 2 is not suitable as the video projection apparatus such as the HMD and the HUD that project the virtual image and is unable to enhance transmission efficiency of light.

Also, in a projector in which an actual image is allowed to be shown as video, a person visually recognizes video illuminated on a screen and thus, the capturing angle of light is preferably large. For that reason, the capturing angle of light was made large so that brightness could be enhanced.

A configuration of the reflector like PTL 3 is not suitable for a surface-emitting light source such as the LED and is unable to enhance efficiency. Even when a plurality of lenses like an exit of the light pipe are combined, light in the outside becomes useless and efficiency cannot be enhanced. The use of a plurality of lenses is also not preferable in terms of cost.

Even when PTL 1, PTL 2, and PTL 3 are combined, it is unable to implement an illumination device having high efficiency as a video projection apparatus which projects a virtual image and of which the capturing angle of light is limited.

An object of the invention is to provide an illumination device and an illumination method that have high light efficiency, and a video projection apparatus using thereof.

### Solution to Problem

In order to solve the problems described above, as an example of the invention, there is provided an illumination device that includes a light source and a light condensing body which is formed with a transparent material and is for condensing light from the light source to be emitted, and the light condensing body includes an incidence surface of a light source side, an emission surface emitting light, and a side surface present between the incidence surface and the emission surface, and the side surface is a curved surface of which a distance from a light axis in a direction orthogonal to a light emitting surface of the light source at the center of the light source becomes large from the incidence surface toward the emission surface and is configured to have a plurality of curved-surface-shapes of which shapes of the curved surfaces are different from each other.

There is provided an illumination device that includes a light source, a light integrator homogenizing light emitted from the light source through total internal reflection and filled with a transparent material, a lens converting light emitted from the light integrator into substantially parallel light, and a reflection parabolic surface converting light emitted from the light integrator disposed on the outside of the lens with respect to a light axis center of the lens, and the illumination device may be configured such that a scattering element that scatters light is included inside the light integrator, a surface of the light integrator side of the lens is disposed on a side closer to the light integrator side than an end in the light axis direction of the lens which is located at a side opposite to the light integrator of the reflection parabolic surface.

### Advantageous Effects of Invention

According to the invention, it is possible to provide a small illumination device of which brightness is enhanced with power-saving, an illumination method, and a video projection apparatus using thereof.

### BRIEF DESCRIPTION OF DRAWINGS

FIG. 1 is a cross-sectional view of an illumination device in Embodiment 1.

FIG. 2 is a perspective view of a light condensing body in Embodiment 1.

FIG. 3 is a diagram for explaining luminance distribution of an illumination region in Embodiment 1.

FIG. 4 is a cross-sectional view of an illumination device in Embodiment 2.

FIG. 5 is a perspective view of a light condensing body in Embodiment 3.

FIG. 6 is a cross-sectional view of an illumination device in Embodiment 4.

FIG. 7 is a diagram for explaining a plural-wavelength light source 9 in Embodiment 4.

FIG. 8 is a perspective view of a light integrator in Embodiment 4.

FIG. 9 is a diagram for explaining a plural-wavelength light source in Embodiment 5.

FIG. 10 is a perspective view of a light integrator in Embodiment 5.

FIG. 11 is a cross-sectional view of a video projection apparatus in Embodiment 6.

FIG. 12 is a cross-sectional view of a video projection apparatus in Embodiment 7.

FIG. 13 is a cross-sectional view of a video projection apparatus in Embodiment 8.

FIG. 14 is a diagram for explaining an application example of a video projection apparatus in Embodiment 9.

FIG. 15 is a diagram for explaining an HMD in Embodiment 10.

FIG. 16 is a diagram for explaining a smartphone in Embodiment 11.

FIG. 17 is a diagram for explaining a usage scene of a smartphone in Embodiment 11.

FIG. 18 is a diagram for explaining a system of the smartphone in Embodiment 11.

FIG. 19 is a diagram for explaining an operation flow of the smartphone in Embodiment 11.

FIG. 20 is a diagram for explaining an operation flow of color adjustment of a video projection apparatus 170 in Embodiment 11.

FIG. 21 is a perspective view of an illumination device in Embodiment 12.

FIG. 22 is a development view of the illumination device in Embodiment 12.

FIG. 23 is a cross-sectional view of the illumination region in Embodiment 12.

FIG. 24 is a development view of a lens in Embodiment 12.

FIG. 25 is a perspective view of a reflector case in Embodiment 12.

FIG. 26 is a diagram for explaining angle distribution of light emitted from a light integrator in Embodiment 12.

### DESCRIPTION OF EMBODIMENTS

In the following, embodiments of the invention will be described using the drawings. The invention is not limited thereto.

### Embodiment 1

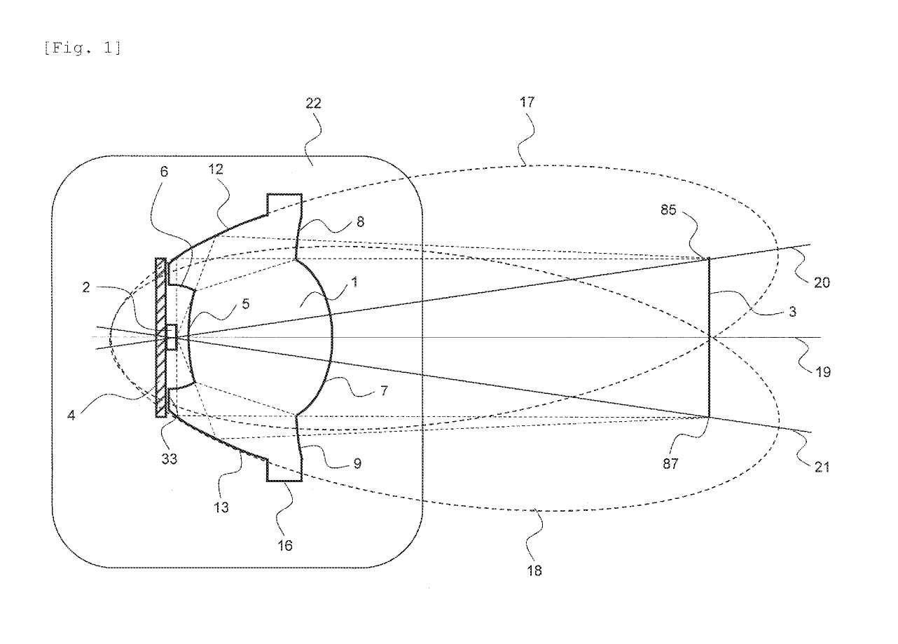

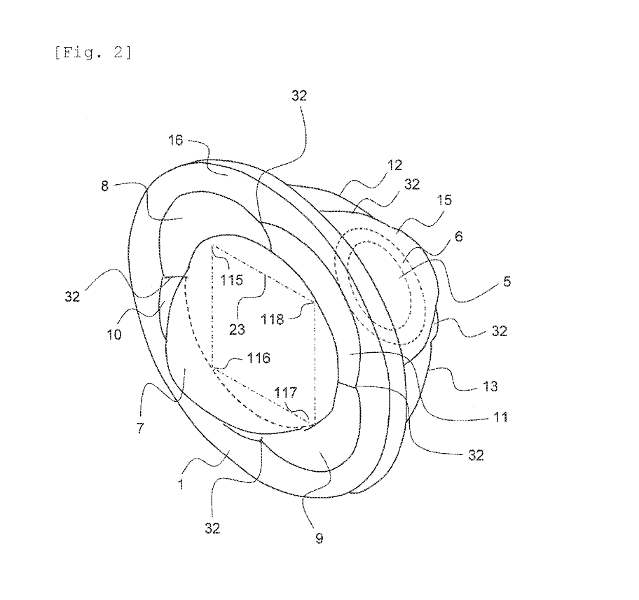

In the present embodiment, an illumination device will be described. FIG. 1 is a cross-sectional view of an illumination device 22 in the present embodiment. FIG. 2 is a perspective view of a light condensing body 1 when viewed from an obliquely upward direction of an illumination region 3 of FIG. 1.

In FIG. 1, the illumination device 22 is configured to include the light condensing body 1 and a light source 2. Light emitted from the light source 2 is condensed by the light condensing body 1 and is illuminated on the illumination region 3. The illumination region 3 is a quadrangular region and a region 23 of FIG. 2 indicates a region obtained by projecting the illumination region 3 on the light condensing body 1. An end 85 of the illumination region 3 corresponds to an end 115 of the region 23 and an end 87 corresponds to an end 117 of the region 23.

As illustrated in FIG. 2, the light condensing body 1 is an optical component molded with the transparent material and is formed with incidence surfaces 5 and 6 of the light source 2 side, five emission surfaces 7 to 11 that emit light, four side surfaces 12 to 15 (side surface 14 is not seen because of a rear side and thus, is not illustrated) . As a material of the light condensing body 1, for example, a transparent material such as polycarbonate or cycloolefin polymer, of which light absorption in a visible light region is small, is preferable. The material may be changed based on a wavelength band of a light source to be used.

On the incidence surfaces 5 and 6 and the emission surfaces 7 to 11, an antireflective film may be formed with a dielectric multilayer film in order to prevent surface reflection of light and improve efficiency.

In FIG. 1, the light source 2 is a surface emission type light source and, for example, an LED, an OLED, and the like are suitable. Here, a white LED, which converts blue light into white light, obtained by applying a phosphor to a surface of a chip is assumed. The light source 2 is mounted on a light source substrate 4 and is able to supply the current from outside through the light source substrate 4.

Normally, light emitted from the surface emission type light source advances in all directions in front. Light emitted from the light source 2 also advances toward the front. A light axis of the light source 2 is an axis (axis 19 in the figure) in a direction orthogonal to a light emitting surface of the light source at the center of the light source and, among light emitted from the light source 2, light of the light axis center becomes the strongest, light becomes weaker as it goes away from the light axis center, light becomes the weakest in the same direction as a light emitting surface of the light source 2.

Light emitted from the light source 2 is incident on the incidence surface 5 including the axis 19 and the incidence surface 6 disposed at the outside of the incidence surface 5 in a direction away from the axis 19 and divided into light of the inner side and light of the outer side by the light condensing body 1.

Light of the inner side divided by the incidence surface is converted into substantially parallel light by the emission surface 7 and is illuminated on the illumination region 3. That is, the incidence surface 5 and the emission surface 7 have a lens function of making emitted light parallel when the light source 2 is set as an object point having as a point shaped object.

As such, the more substantially parallel light to be emitted, the higher the efficiency as the illumination device for the video projection apparatus which projects the virtual image and of which the capturing angle of light is limited.

In FIG. 1, although the incidence surface 5 and the emission surface 7 are convex lenses, of course, the incidence surface 5 maybe a concave lens as long as the incidence surface 5 has a lens function of making emitted light parallel when the light source 2 is set as an object point.

On the other hand, light of the outer side divided by the incidence surface 6 is reflected on the side surface 12 to be illuminated on the illumination region 3 through the emission surface 8 or reflected on the side surface 13 to be illuminated on the illumination region 3 through the emission surface 9. Although description is not made in FIG. 1, similarly, light of the outer side divided by the incidence surface 6 is respectively reflected on the side surfaces 14 and 15 to be illuminated to the illumination region 3 through the emission surfaces 10 and 11.

Matters that by the Snell's law, a light beam having an incident angle larger than a critical angle is unable to advance from a medium with higher refractive index to a medium with lower refractive index and is subjected to total internal reflection (hereinafter, denoted by TIR) are known. For that reason, the light beam which incidents on the side surfaces 12 and 13 is reflected in the TIR manner. The side surfaces 12 to 15 may be reflection-coated with aluminum and silver alloy or the like. In this case, it may be joined with other components on a reflection coat surface by an adhesive.

Next, a light path along which light from the incidence surface 6 passes four side surfaces 12 to 15 and four emission surfaces 8 to 11 will be described.

First, a light path constituted with the incidence surface 6, the side surface 12, and the emission surface 8 will be described. In FIG. 1, the incidence surface 6 is a portion of a shape of a sphere having the center of the light source 2 as an origin. For that reason, light which is emitted from the center of the light source 2 and incident on the incidence surface 6 is perpendicular to the incidence surface 6 and thus, light advances to the side surface 12 at the angle at the time when light is emitted from the light source 2 as it is without being subjected to influence by which an angle is bent.

The side surface 12 is a curved surface having a distance from the axis 19 becomes large from the incidence surface toward the emission surface side. In the present embodiment, the side surface 12 is a portion of an ellipsoid 17 using an axis 20 as a rotation axis. Normally, an ellipsoid has two foci and a property that an image of a light beam emitted from one focus is formed on the other focus. When the center of the light source 2 and the end 85 of the illumination region 3 are set as two foci, it becomes possible to form an image of light emitted from the light source 2 on the end 85 of the illumination region 3. For that reason, the light beam reflected on the side surface 12 advances toward the end 85.

The emission surface 8 has a shape of a portion of a sphere having the end 85 as an origin. The light beam which is incident on the emission surface 8 is light of which a focus is the end 85 and thus, is perpendicular to the emission surface 8. For that reason, light advances to the end 85 at the angle by the emission surface 8 as it is without being subjected to influence by which an angle is bent.

That is, it is possible to illuminate light of a range from the same angle (emission light in a direction perpendicular to the axis 19 in FIG. 1) as the emission plane of the light source 2 to an angle divided by the boundary of the incidence surfaces 5 and 6 on the end 85, as light of a predetermined angle range (angle range due to limitation in capturing angle of light, in other words, the capturing angle of light is proportional to an inverse number of the F-number and thus, it may be regarded as an angle range due to limitation in the F-number).

As such, the light condensing body 1 illuminates light of the outer side emitted from the light source 2 on the end of the illumination region 3 so as to make it possible to illuminate light of the outer side of the light source 2 on the illumination region 3, as light limited to a predetermined angle range.

Next, a light path constituted with the incidence surface 6, the side surface 13, and the emission surface 9 will be described. Similar to the side surface 12, the side surface 13 is a portion of a shape of the ellipsoid 18 using an axis 21 as a rotation axis. In the ellipsoid 18, the center of the light source 2 and the end 87 of the illumination region 3 are set as the two foci. Similar to the emission surface 8, the emission surface 9 has a shape of a portion of a sphere having the end 87 as an origin. For that reason, an image of light emitted from the light source 2 is formed on the end 87. That is, the axis 20 and the axis 21 are cross-linked each other at the light source 2 so as to make it possible to form an image of light emitted from the light source 2 at both ends of the illumination region.

Similarly, also, in a light path constituted with the incidence surface 6, the side surface 14, and the emission surface 10 and a light path constituted with the incidence surface 6, the side surface 15, and the emission surface 11, the side surface 14 and the side surface 15 are portions of the ellipsoid and the ellipsoid has two foci set as the center of the light source 2 and the end 116 or 118 of the illumination region 3 and thus, an image of light emitted from the light source 2 is formed on the ends of the illumination region 3 which correspond to the ends 116 and 118. As illustrated in the perspective view of FIG. 2, in the light condensing body 1, the emission surfaces 8 to 11 have different curved surface shapes and thus, respective boundaries 32 occur at joining portions thereof. Similarly, the side surfaces 12 to 15 also have different curved surface shapes and thus, respective boundaries 32 also occur at the joining portions thereof. The boundaries 32 of the side surfaces and the emission surfaces mean that the side surfaces and the emission surfaces are divided by parallel surfaces passing through the axis 19. As described above, among light emitted from the light source 2, light of the inner side is illuminated on the illumination region 3 at a substantially parallel angle while light of the outer side is condensed on both sides of the illumination region 3, by the light condensing body 1.

The light condensing body 1 maybe used as a surface which forms a surface 33, and contacts and fixes the light source substrate 4. The light condensing body 1 may be used as a surface provided with a flange 16 and fixing the illumination device 22 and other components. The surface 33 and the flange 16 are also provided in a region through which a valid light beam does not pass and there is no loss of light.

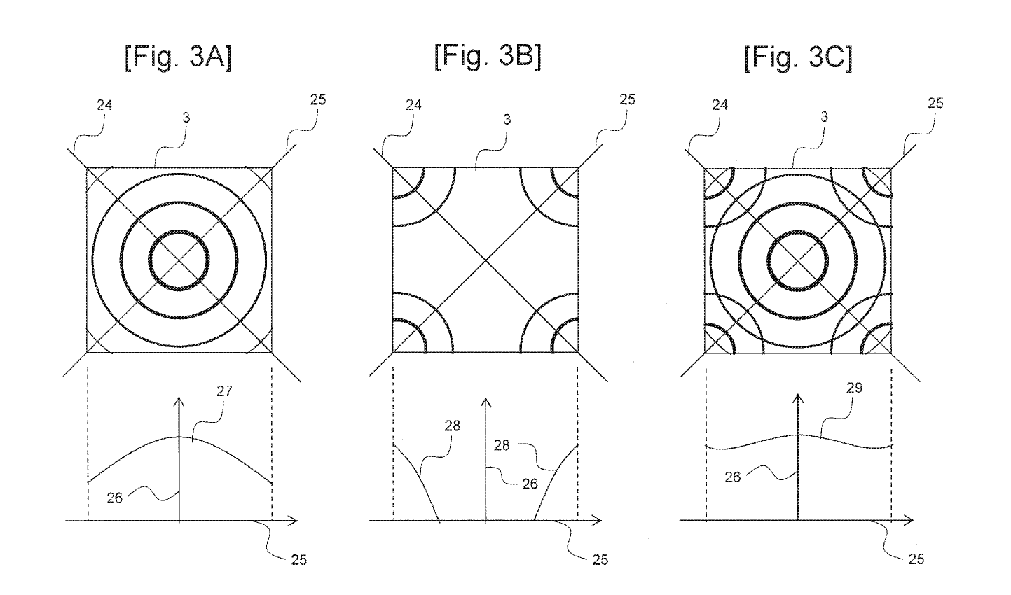

FIG. 3 is a diagram for explaining luminance distribution of the illumination region 3. FIG. 3(A) illustrates luminance distribution of light of the inner side of the light source 2 emitted from the emission surface 7, FIG. 3(B) illustrates luminance distribution of light of the outer side of the light source 2 emitted from the emission surfaces 8 to 11, and FIG. 3 (C) illustrates luminance distribution of light of the inner side and light of the outer side emitted from the light source 2. The upper end of the drawing illustrates a luminance contour line of luminance of the illumination region 3 and indicates that the thicker the line, the greater the luminance. The lower end of the drawing illustrates distribution of luminance 26 projected on the axis 25 illustrated in the upper end of the drawing.

As illustrated in luminance distribution 27, luminance of the center of the illumination region 3 of light of the inner side is large, and luminance becomes smaller as light of the inner side goes toward the outside. The illumination region 3 is a quadrangle and thus, luminance at four corners is especially small. In contrast, as illustrated in luminance distribution 28, luminance only at the four corners of the illumination region 3 of light of the outer side is large. For that reason, luminance distribution of light emitted from the light source 2 becomes the sum of luminance distribution 27 and 28 and luminance is enhanced as a whole by the light condensing body 1, as illustrated in luminance distribution 29.

As such, although four corners become dark when a normal lens is used, four corners can become bright when the light condensing body 1 is used in the present embodiment. This is because light of the outer side which was not able to be used by the normal lens is used so as to make it possible to efficiently illuminate the illumination region 3.

In the video projection apparatus which is for the virtual image and has predetermined limitation in the capturing angle of light, as described above, light of the center of the light source 2 is made substantially parallel by using the light condensing body 1 and light of the outer side which falls within a predetermined angle range is illuminated on the illumination region from outside of the illumination region so as to make it possible to efficiently illuminate light from the light source 2 on the illumination region 3.

In the embodiment described above, although an example in which the two foci of the ellipsoid are the light source 2 and the end of the illumination region is described, for example, even in a case where a focus is slightly shifted into a plane of the light source 2 or the illumination region or in a direction parallel to the axis 19, similar effects are obtained by making a plurality of axes of the ellipsoids different. That is, the axis of a rotating body may be available as long as the axis at least passes through the light source and a portion between the center of the targeted illumination region and the end of the illumination device.

As described above, in the present embodiment, an illumination device is configured to include a light source and a light condensing body which is formed with a transparent material and condenses light from the light source to be emitted, and the light condensing body includes an incidence surface of a light source side, an emission surface emitting light, and a side surface which is present between the incidence surface and the emission surface, and the side surface is a curved surface of which a distance from a light axis in a direction orthogonal to the light emitting surface of the light source at the center of the light source becomes large from the incidence surface toward the emission surface, and has a plurality of curved-surface-shapes of which shapes of the curved surfaces are different from each other.

An illumination method of the illumination device that condenses light emitted from the light source to be emitted is configured in such a way that light emitted from the light source is divided into light of the inner side which is a light axis side and light of the outer side which is away from the light axis in a direction orthogonal with respect to the light axis which is in a direction orthogonal to the emitting surface from the center of light source, light of the inner side is illuminated on the illumination region of the illumination device at a substantially parallel angle, and light of the outer side is condensed to be focused on a corner of the illumination region.

With this, it is possible to provide a small illumination device of which brightness is enhanced with power-saving, an illumination method, and a video projection apparatus using thereof.

### Embodiment 2

In the present embodiment, an illumination device having a configuration different from that of Embodiment 1 will be described. In the present embodiment, an illumination device 52 is another example of the illumination device 22 and is different from the illumination device 22 in that the curved surface of the side surface of the light condensing body is formed with a parabolic line.

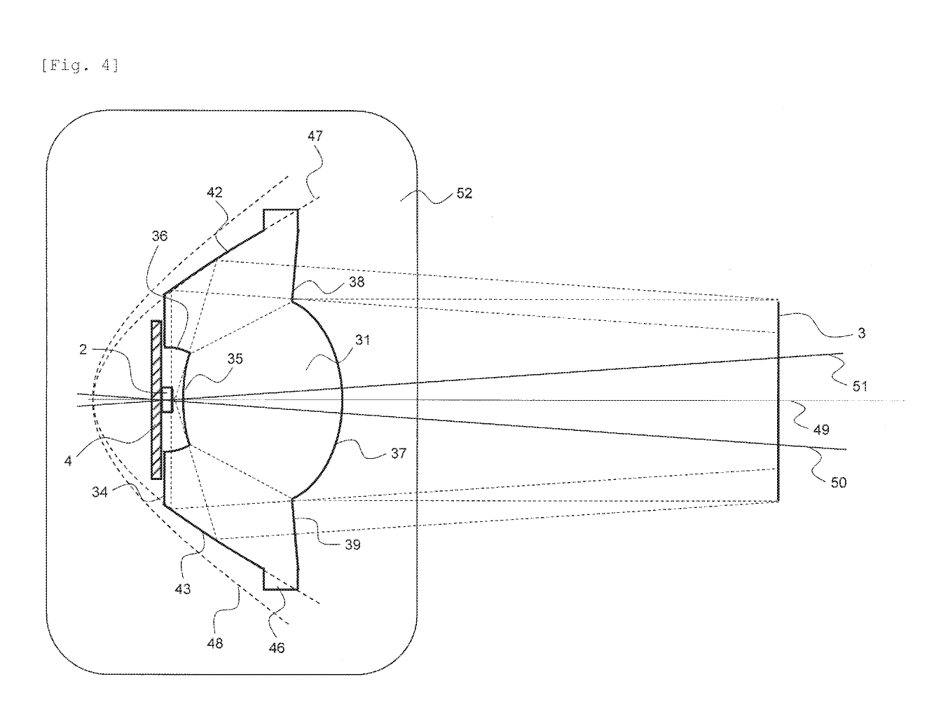

FIG. 4 is a cross-sectional view of the illumination device 52 in the present embodiment. In FIG. 4, the illumination device 52 is configured to include a light condensing body 31 and the light source 2. Light emitted from the light source 2 is condensed by the light condensing body 31 and is illuminated on the illumination region 3.

The light condensing body 31 is an optical component molded with the transparent material and is formed with incidence surfaces 35 and 36 of the light source 2 side, five emission surfaces 37 to 41 (only emission surfaces 37 to 39 are illustrated in the figure) that emit light, and four side surfaces 42 to 45 (only side surfaces 42 and 43 are illustrated in the figure).

On the incidence surfaces 35 and 36 and five emission surfaces 37 to 41, an antireflective film may be formed with a dielectric multilayer film in order to prevent surface reflection of light and improve efficiency.

Light emitted from the light source 2 is incident on the incidence surface 35 including the axis 49 and the incidence surface 36 disposed at the outside of the incidence surface 35 with respect to the axis 49 by the light condensing body 31 and divided into light of the inner side and light of the outer side.

Light of the inner side divided by the incidence surface 35 is converted into substantially parallel light by the emission surface 37 and is illuminated on the illumination region 3. That is, the incidence surface 35 and the emission surface 37 have a lens function of making emitted light parallel when the light source 2 is set as an object point.

Light of the outer side divided by the incidence surface 36 is reflected on the side surface 42 to be illuminated to the illumination region 3 through the emission surface 38 or reflected on the side surface 43 to be illuminated on the illumination region 3 through the emission surface 39. Although description is not made in FIG. 4, similarly, light of the outer side divided by the incidence surface 36 is reflected on the side surfaces 44 and 45 to be illuminated on the illumination region 3 through the emission surfaces 40 and 41.

Next, a light path along which light from the incidence surface 36 passes four side surfaces 42 to 45 and four emission surface 38 to 41 will be described.

First, a light path constituted with the incidence surface 36, the side surface 42, and the emission surface 38 will be described. The incidence surface 36 is a portion of a shape of a sphere having the center of the light source 2 as an origin. For that reason, light which is emitted from the light source 2 advances to the side surface 42 at the angle as it is. The side surface 42 is a curved surface having a distance from the axis 49 becomes large from the incidence surface toward the emission surface side. In the present embodiment, the side surface 42 is assumed as a portion of a parabolic line 47 using an axis 50 as a rotation axis. Normally, a parabolic line has a single focus and a property that the light beam emitted from the focus becomes parallel. When the center of the light source 2 is set as a focus thereof and the rotation axis is inclined at a predetermined angle like the axis 50, the light beam inclined at a predetermined angle is obtained. For that reason, the light beam reflected on the side surface 42 advances toward the illumination region 3 at a predetermined angle.

The emission surface 38 is a plane orthogonal to the axis 50. The light beam incident on the emission surface 38 is light parallel to the axis 50 and thus, is perpendicular to the emission surface 38. For that reason, light advances to the illumination region 3 at the angle by the emission surface 38 as it is without being subjected to influence by which an angle is bent.

Similarly, also, in a light path constituted with the incidence surface 36, the side surfaces 43 to 45, and the emission surfaces 40 and 41, the side surfaces 43 to 45 are a portion of the parabolic line and the parabolic line has a focus which is set as the center of the light source 2 and thus, light emitted from the light source 2 respectively advances toward the illumination region 3 at a predetermined angle.

That is, light of the outer side is illuminated from both outsides of the illumination region 3 at a predetermined angle and thus, light of the outer side of the light source 2 can be illuminated on the illumination region 3 without hindering light of the inner side. Also, in the light condensing body 31, boundaries occur at joining portions of the emission surfaces having different shapes and the side surfaces. As described above, among light emitted from the light source 2, light of the inner side is illuminated on the illumination region 3 at a substantially parallel angle and on the other hand, light of the outer side is illuminated on both sides of the illumination region 3 from the outside of the illumination region 3 at a predetermined angle, by the light condensing body 31.

The light condensing body 31 may be used as a surface which forms a surface 34, and contacts and fixes the light source substrate 4. The light condensing body 31 may be used as a surface provided with a flange 46 and fixing the illumination device 52 and other components. The surface 34 and the flange 46 are also provided in a region through which the valid light beam does not pass and there is no loss of light.

In the video projection apparatus which is for the virtual image and has predetermined limitation in the capturing angle of light, as described above, light of the center of the light source 2 is made substantially parallel and light of the outer side which falls within a predetermined angle range is illuminated on the illumination region from outside of the illumination region by using the light condensing body 31 so as to make it possible to efficiently illuminate light from the light source 2 on the illumination region 3.

### Embodiment 3

In the present embodiment, a light condensing body having a configuration different from that of Embodiment 1 will be described. In the present embodiment, a light condensing body 61 is another example of the light condensing body 1 and is applied in a case where the illumination region is rectangular.

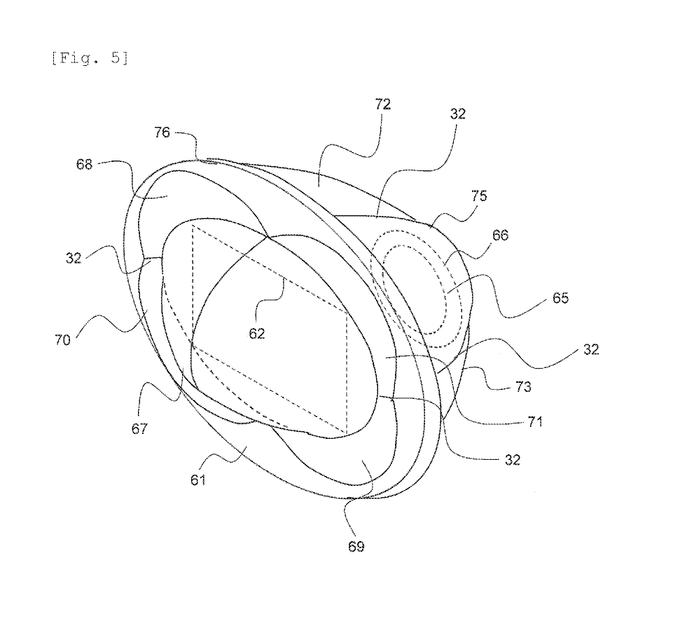

FIG. 5 is a perspective view of the light condensing body 61 in present embodiment. In FIG. 5, the light condensing body 61 is an optical component molded with the transparent material and is formed with incidence surfaces 65 and 66 onto which light is incident, five emission surfaces 67 to 71 which emit light, and four side surfaces 72 to 75 (side surface 74 is not illustrated) . The same material as the light condensing body 1 described in FIG. 2 may be used as the material of the light condensing body 61.

On the incidence surfaces 65 and 66 and emission surfaces 67 to 71, an antireflective film may be formed with a dielectric multilayer film in order to prevent surface reflection of light and improve efficiency.

Incidented light is incident on the incidence surface 65 including the center axis of light and the incidence surface 66 disposed at the outside of the incidence surface 65 with respect to the axis and divided into light of the inner side and light of the outer side, by the light condensing body 61.

Light of the inner side divided by the incidence surface 65 is converted into substantially parallel light by the emission surface 67 and is illuminated on the illumination region. That is, the incidence surface 65 and the emission surface 67 have a lens function of making emitted light parallel when the light source is set as an object point. The incidence surface 65 and the emission surface 67 of the light condensing body 61 are the lenses having radiuses that differ vertically and horizontally, unlike the light condensing body 1. For that reason, it is possible to efficiently illuminate light on a rectangular illumination region.

The region 62 illustrates a region obtained by projecting the illumination region on the emission surface side.

In a case of a normal lens having equal aspect ratio, aspect ratio of illuminated light becomes equal and useless light which is not illuminated is generated in an illumination region with unequal aspect ratio. For that reason, efficiency can be improved by the lens of which aspect ratio is changed.

The more the substantially parallel light to be emitted, the greater the efficiency as the illumination device for the video projection apparatus of which the capturing angle of light is limited and which projects the virtual image.

Light of the outer side divided by the incidence surface 66 is reflected on the side surfaces 72 to 75 to be illuminated to the illumination region through the emission surfaces 68 to 71.

The side surfaces 72 to 75 are curved surfaces having a distance from the axis 49 becoming large from the incidence surface toward the emission surface side and here, the side surfaces are assumed as portions of the ellipsoid. One focus of each side surface is set as the center of the light source and the other focus of each side surface is set as each end of the illumination region. For that reason, an image of light of the outer side emitted from the light source can be formed on the end of the illumination region.

The emission surfaces 68 to 71 are portions of a shape of a sphere obtained by setting the end of the illumination region as an origin. For that reason, light reflected on the side surfaces 72 to 75 advances to the illumination region at the angle as it is without being subjected to influence by which an angle is bent by the emission surfaces 68 to 71. As illustrated in the perspective view of FIG. 5, in the light condensing body 61, the emission surfaces 68 to 71 and the side surfaces 72 to 75 have different shapes and thus, respective boundaries 32 occur at joining portions therebetween. As described above, according to the present embodiment, it is possible to efficiently condense light emitted from the light source also in the rectangular illumination region.

The light condensing body 61 may also be used as a surface which contacts a light source substrate and a surface provided with a flange 76 and fixing the light source and other components. The surface and the flange 76 are provided in a region through which efficient light beam does not pass so as to make it possible to avoid loss of light.

In the video projection apparatus which is for the virtual image and has predetermined limitation in the capturing angle of light, as described above, light of the center of the light source 2 is made substantially parallel and light of the outer side which falls within a predetermined angle range is illuminated on the illumination region from outside of the illumination region by using the light condensing body 61 so as to make it possible to efficiently illuminate light from the light source 2 on the rectangular illumination region.

### Embodiment 4

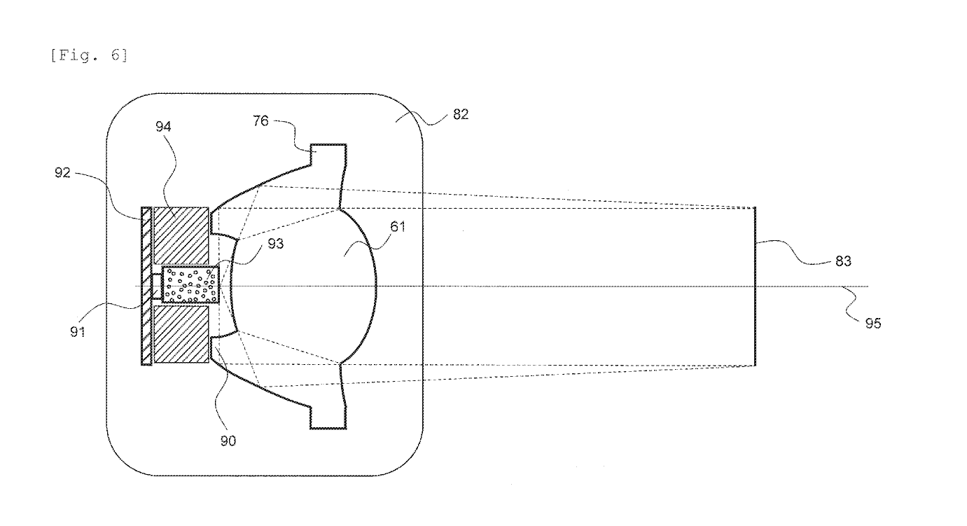

In the present embodiment, an illumination device having another configuration will be described. FIG. 6 is a cross-sectional view of an illumination device 82 in the present embodiment. In FIG. 6, the illumination device 82 is configured to include the light condensing body 61 (light condensing body described in Embodiment 3) and a plural-wavelength light source 91. Light having a plurality of wavelengths and emitted from the plural-wavelength light source 91 is incident on a light integrator 93 and is uniformly color-mixed. Light emitted from the light integrator 93 is condensed by the light condensing body 61 and is illuminated on an illumination region 83. The illumination region 83 is a rectangle having aspect ratio of 16:9 which is general for a display device.

Here, the plural-wavelength light source 91 is a surface emission type light source emitting three kinds of wavelengths and here, an LED provided with three chips having red, green, and blue wavelength bands is assumed as the plural-wavelength light source 91. The plural-wavelength light source 91 is mounted on a light source substrate 92 and is able to supply the current from outside through the light source substrate 92.

Three chips of the plural-wavelength light source 91 are disposed at different positions. For that reason, light axes of respective chips are different from each other. The light integrator 93 is disposed in order to make the light axes coincide with each other.

As described above, light emitted from the light integrator 93 is divided into light of the inner side and light of the outer side including a light axis 95 by the light condensing body 61, and light of the inner side is illuminated on the illumination region 83 at a substantially parallel angle while light of the outer side is condensed on both sides of the illumination region 83, by the light condensing body 61.

A surface 90 of the light condensing body 61 contacts with a tunnel mechanism 94, and the tunnel mechanism 94 contacts with the light source substrate 92 to be fixed. The flange 76 may be used as a surface which fixes the illumination device 82 and other components thereof.

The tunnel mechanism 94 is assumed as a mechanism fixing the light integrator 93 by light press-insertion. When the light integrator 93 and the tunnel mechanism 94 are fixed by an adhesive, a refractive index difference at a contact surface between the light integrator 93 and the adhesive is reduced, light is leaked, and loss of light is increased. For that reason, the tunnel mechanism 94 can fix the light integrator 93 without using the adhesive and thus, it is an efficient fixing method.

The tunnel mechanism 94 also has a light shielding effect that can eliminate unnecessary light which is emitted from the plural-wavelength light source 91, passes through the light condensing body 61, and advances to the illumination region 83 without passing through the light integrator 93.

The illumination device 82 has a plurality of wavelengths and thus, is able to adjust color of the illumination region 83.

In general, a display device without the color filter needs a light source having wavelength bands of red, green, and red for colorization and the illumination device 82 is suitable for such display device.

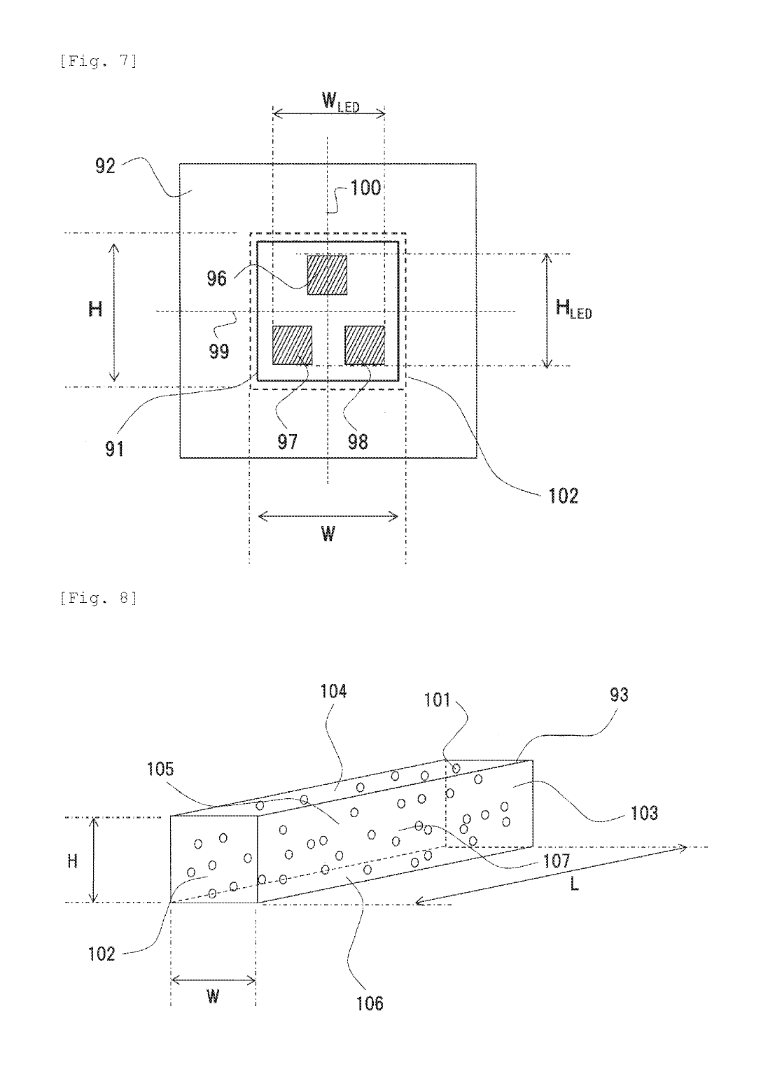

FIG. 7 is a diagram for explaining the plural-wavelength light source 91. In the plural-wavelength light source 91, a first wavelength light source 96, a second wavelength light source 97, and a third wavelength light source 98 that respectively emit light having wavelength bands of red, green, and red are disposed in a triangle inside the portion formed with a width W_{LED} and a height H_{LED}.

When the light axis (axis 95) of the light condensing body 61 and the center (intersection point between axis 99 and axis 100) of the first wavelength light source 96, the second wavelength light source 97, and the third wavelength light source 98 are made to coincide with each other, light can be efficiently condensed by the light condensing body 61.

When the width W_{LED} and the height H_{LED} are set to be smaller than a surface 102 (width W, height H) of the light integrator 93, it is possible to efficiently transmit light to the light integrator.

In order to mix light in a short distance, it is preferable that the width W and the height H of the light integrator 93 are small. For that reason, the first wavelength light source 96, the second wavelength light source 97, and the third wavelength light source 98 are disposed in a triangle.

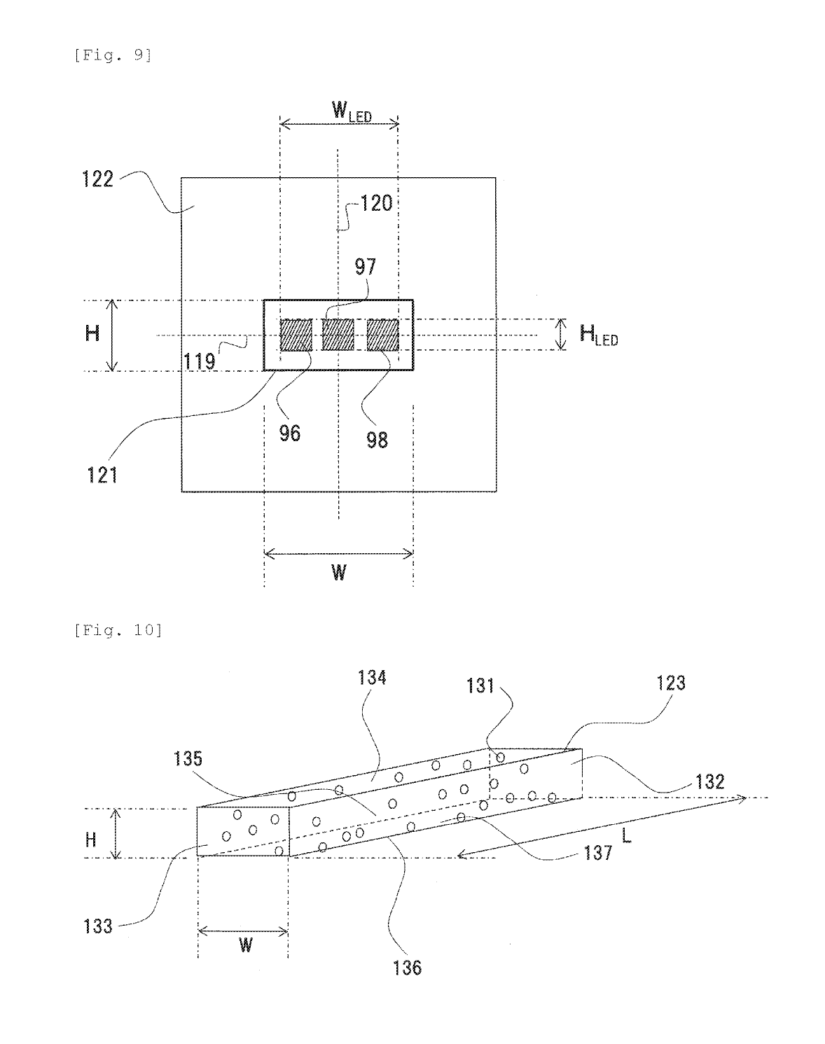

FIG. 8 is a perspective view of a light integrator 93. The light integrator 93 is formed in a quadrangular cylindrical shape having a length L, a height H, and a width W and inside thereof is filled with a medium 1 having predetermined transparency and high refractive index N1. The light integrator 93 has the surfaces 102 to 107.

The surfaces 102 and 103 are surfaces onto which light is incident or surfaces from which light is emitted. The surfaces 104 to 107 are side surfaces having a function of trapping light incident from the surfaces 102 and 103 into the light integrator 93 by the TIR.

Inside of the light integrator 93 is randomly filled with scattering elements 101 each of which is filled with a medium 2 having a refractive index 2, which is different from the medium 1, and which has high transparency. According to the Snell's law, a light beam is emitted at an angle different from an incident angle when the light beam passes through a medium having a different refractive index. The scattering element 101, using that principle, has a function that changes the angle of advancing light beam so as to scatter the light beam. When the difference between the refractive index 1 and the refractive index 2 is made larger, a greater diffusion function can be obtained according to the Snell's law.

The scattering element may have a spherical shape or other shapes. It is preferable that the scattering element has a spherical shape which is a shape of a general-purpose product from the viewpoint of costs.

In a case where the scattering element is formed in a spherical shape, as the diameter thereof becomes smaller, the greater the angle at which the light beam is bent and the higher the scattering performance is obtained. It is preferable that the diameter thereof is greater than a wavelength of an incident light beam and is set to be less than or equal to 10 times the wavelength thereof.

When the diameter of the scattering element is smaller than the wavelength, significant scattering can be obtained. However, a probability that the light beam impinges against the scattering element is small and thus, a filling ratio of the scattering element is increased in order to secure homogeneity, but reduction in efficiency becomes problematic.

In contrast, when the diameter is greater than or equal to 10 times the wavelength, the angle of the light beam capable of being changed becomes smaller and the length of the light integrator 93 is lengthened in order to obtain desirable mixturability and homogeneity, but is unable to contribute to targeted miniaturization.

In a case where ruggedness does not exist on the surface of the scattering element, other than a case where the scattering element is a spherical shape, it is almost the same as matters described above.

A wavelength order of minute structure may be provided on the surface of the scattering element. In this case, even when a shape thereof is made arbitrary and the maximum diameter of the scattering element is made larger, it is possible to expect that significant scattering effect is obtained.

It is preferable that the heights H and the widths W of the surfaces 102 and 103 are set to be substantially the same as the incident light beam or the minimum size obtained by taking into account at least a fitting tolerance. It is most preferable that the heights H and the widths W of the surfaces 102 and 103 are substantially the same as the incident light beam and in this case, the heights and the widths may be adjusted in assembling by taking into account a fitting tolerance.

Luminance of the light beam emitted from the surfaces 102 and 103 is inversely proportional to an area. For that reason, when an area of an incident and emission surface is made twice with respect to an area of an incident light beam, luminance is halved. When the area is made larger, a trapping effect is lowered and mixture performance is reduced. For that reason, it is necessary to increase the filling ratio of the scattering element and efficiency is further degraded.

In contrast, when the areas of the surfaces 102 and 103 are smaller than the incident light beam, the light beam is unable to be captured and thus, efficiency is reduced.

From the matters described above, it is preferable that the areas of the surfaces 102 and 103 are adjusted to be substantially the same as a size of the incident light beam or are set to be at least less than or equal to twice by taking into account an assembly tolerance.

In the widths W and the heights H of the surfaces 102 and 103, it is defined that the width W>the height H. In this case, the length L is preferably longer than three times the length of the width W.

A normal surface light source takes the Lambertian distribution in which the half width at half maximum is 60 degrees. When a refractive index of a general transparent material is set as 1.5, light captured into the light integrator 93 is distributed in a range of ±35 degrees, according to the Snell's law. When the light beam of 35 degrees advances by the length L which is three times the width W, the light beam is reflected approximately twice. That is, the (Expression 1) is satisfied.

L×Tan 35°≥2×W (Expression 1)

When there is a length in which reflection is performed approximately twice, the filling ratio of the scattering element 101 is adjusted so as to make it possible to satisfy mixturability and homogeneity.

In a case where it is set to a length L greater than three times the width W, adjustment to reduce the filling ratio is performed so as to make it possible to maintain efficiency while satisfying mixturability and homogeneity.

For example, in a case where the width W and the height H are set to 1 mm, when the length is set to 4 mm, the diameter of the scattering element 101 is set to approximately 2 μm, the refractive index 1 is set to 1.48, and the refractive index 2 is set to 1.58, the total volume of the medium 2 of the scattering element 101 may be set to a range from 0.5% to 1.0% with respect to the total volume of the medium 1.

The surfaces 102 and 103 are preferably made substantially parallel. Light is able to be incident and emitted while maintaining an average angle of light which is vertically incident, and it is preferable in terms of efficiency.

It is preferable that the surfaces 102 and 103 have the same shape. It is possible to reduce leakage of light due to the TIR, perform efficient reflection, and reduce loss.

The filling ratio of the scattering element 101 is inversely proportional to a mean free path which is an average distance of collision between light and the scattering element 101 and light transmittance is lowered by the number of times of collision between light and the scattering element and thus, is said to be proportional to the mean free path. That is, the filling ratio of the scattering element 101 is inversely proportional to brightness. When it is filled with the scattering element 101, efficiency is lowered and thus, the filling ratio of the scattering element 101 may be determined by taking into account mixturability, homogeneity, and efficiency.

It is preferable that surface roughness of the surfaces 104 to 107 is reduced. The surface roughness is reduced so as to make it possible to reduce leakage of light from the surfaces 104 to 107 to allow high light-amount output.

It is preferable that the surface roughness in a length direction is smaller than that in a direction orthogonal to the length direction. In this case, roughening having anisotropy easily occurs due to a processing method (cutting or molding) or the like, but the surface roughness in the light axis direction is made small so as to make it possible to reduce light leaking from a reflecting side surface to allow high light-amount output.

The surface coarseness of the surfaces 102 and 103 may be made large. In this case, the incident and emission surface is roughened so that uniformization of light due to surface scattering is possible.

Although the light integrator of the present embodiment is not particularly limited as long as the light integrator has a configuration in which the medium 1 and a scattering element (medium 2) which has a refractive index different from the medium 1 and scatters propagating light are filled, the light integrator can be easily obtained by using material and a manufacturing method which will be described in the following.

First, as material of the medium 1, material having high transparency is selected from the point of view of allowing light to propagate. In the present embodiment, acrylic photo-curable resin is used but is not particularly limited as long as material having high transparency is used. For example, epoxy-based thermosetting resin or thermoplastic resin such as acryl or polycarbonate, glass, or the like may be used.

When photo-curable resin is used, it is more preferable from the point of view that mixing with the medium 2 is easy when a solid medium 2 is used, from the point of view that a process such as cooling or drying is not required after curing and thus, working efficiency is improved, and from the point of view that a light integrator having a predetermined shape is easily obtained. When acrylic material is used, it becomes possible to increase transmittance and increase utilization efficiency of light and thus, it is more preferable.

Next, the medium 2 can be efficiently obtained by mixing particles having the refractive index different from that of the medium 1 into the medium 1. In the present embodiment, although cross-linked polystyrene fine particles are used as material of the medium 2, other materials such as plastic particles or glass particles having other material maybe used as long as the material has high transparency. However, presence of the refractive index difference is important to scatter light and thus, it is preferable that the refractive index difference between the medium 1 and the medium 2, which is greater than or equal to 0.005, is present. When the difference is in a range from 0.005 or more to 0.015 or less, it is more preferable from the point of view that specific gravity of the medium 1 and that of the medium 2 are easily brought close to each other and the medium 2 is easily mixed with the medium 1 and from the point of view that lowering of efficiency is suppressed and scattering effect is easily obtained. Here, when the refractive indexes of the medium 1and the medium 2 are compared, the refractive index of the medium 1 may be large or the refractive index of the medium 2 may be larger. In the present embodiment, the refractive index difference is a value calculated from the difference between the medium 1 or the medium 2 that has a higher refractive index and the medium 2 or the medium 1 that has a lower refractive index, among the medium 1 and the medium 2.

Next, it is preferable that a particle diameter of the medium 2 is in a range from 0.5 μm or more to 5 μm or less. This is because, as described above, when the particle diameter is small, light is scattered excessively and light capturing efficiency is reduced, and when the particle diameter is large, scattering of light becomes difficult. Although it is preferable that the particle diameters are substantially uniform, if 90% or more particles are included in the particle diameter range, the effect can be obtained and thus, there is no problem.

Next, as a method for integrating the medium 1 and the medium 2, for example, there is a manufacturing method in which a liquid medium 1 is prepared, the medium 1 and the medium 2 are mixed with each other, and the mixed medium is photo-cured to have a predetermined shape. It is possible to manufacture by other methods such as thermal press, injection molding, cutting, and the like. Among them, if a liquid medium 1 is used, the medium 2 can be easily mixed and thus, it is more preferable, and if a state where the medium 2 is mixed into the medium 1 is liquid, it is easy to process the medium into a predetermined shape and thus, it is much more preferable.

At the time of preparing a product shape, it may be manufactured in such a way that the outer periphery of a plate having a height of a product may be cut to be a product size after manufacturing and a mold having space of a product size is fabricated and resin is poured into the mold to be cured.

Next, surface roughness will be described. It is preferable that surface roughness (Ra; arithmetic average roughness) of the light integrator of the present embodiment is small in a length direction of the side surface. This is because when light is present in the side surface, if a surface is roughened in the length direction of the side surface, light exceeds a critical angle and comes off from the side surface. In a direction perpendicular to the length direction, the surface may be roughened in a range in which an adverse effect is not exerted for propagation of light. For the incidence surface of light or the emission surface of light, increase of diffusion of light can be expected and thus, the surface may be roughened in a range in which an adverse effect is not exerted for emission of light. From the point of view described above, surface roughness of the side surface in the light axis direction may be in a range from 0 μm to 2.0 μm. Preferably, a range from 0 μm to 1.0 μm is better and a range from 0 μm to 0.5 μm is further better. It is preferable that surface roughness of the light incidence surface and the light emission surface is greater than or equal to the surface roughness of the side surface and it is 0.01 μm to 10 μm, it is more preferable if it is 0.5 μm to 5 μm, and it is much more preferable if it is 0.5 μm to 3 μm. Also, surface roughness in a vertical direction with respect to the light axis of the side surface exceeds 0 μm and an upper limit thereof may be less than or equal to values listed for the surface roughness of the light incidence surface and the light emission surface.

Although it is preferable that the surface roughness in a vertical direction with respect to the light axis (length L direction in the figure) of the side surface is small within the range described above, it maybe arbitrarily selected from the point of view of processing efficiency. Specifically, in a case where, for example, the side surface is formed by cutting processing, as for surface roughness in a cutting direction and surface roughness in a direction substantially perpendicular to the cutting direction, the former of the surface roughness in the cutting direction tends to be small and when a cutting speed or the like is changed in order to improve processing efficiency, especially, the surface roughness in the vertical direction to the cutting direction is roughened. In this case, it is possible to hold propagating efficiency of light while maintaining working efficiency by setting the cutting direction as the light axis direction. In a case where molding or the like is used and directionality of surface roughness such as a cutting scratch is included in a casting mold side for molding, the surface roughness is transferred to the light integrator. Also, in this case, similarly, the light axis direction is set to a direction in which surface roughness is small so as to make it possible to hold good light propagating efficiency.

In a case where solid particles are used in the medium 2, when unevenness which consists of the projection portion due to protrusion of scattering elements consisting of the medium 2 from the side surface and/or the recessed portion due to traces of the scattering element fallen off from the side surface is present to the extent that the unevenness contributes to surface coarseness, it becomes one of causes of leakage of light from the side surface occurring as described above. From the matters described above, furthermore, the surface roughness (Ra) of the side surface may be less than or equal to ½ of an average particle diameter of the scattering elements introduced as the medium 2. This can be implemented by cutting the scattering element, which protrudes from the side surface or is in a state of being not protruded from the side surface of the light integrator, using polishing or cutting, and smoothing the scattering element.

For example, as the medium 1, Hetaloid (registered trademark) 9501 manufactured by Hitachi Chemical Company, Ltd. is used. This is urethane acrylate-based photo-curable resin. Transparency thereof is high and the refractive index thereof is 1.49. As the medium 2, Techpolymer (registered trademark) SSX-302ABE manufactured by SEKISUI PLASTICS CO., Ltd is used. This is fine particles made of cross-linked polystyrene resin and is mono-disperse particles of which shape is a sphere and an average diameter is 2 μm and approximately 95% of the total particles have the diameter of which size is within 0.5 μm of an average diameter. Transparency thereof is high and the refractive index thereof is 1.59.

In a case where it is set that the width W and the height H are 1.05 mm, the length L is 4.15 mm, the total volume of the medium 2 of the scattering element with respect to the total volume of the medium 1 is 0.5%, the light integrator may be manufactured as follows. First, fine particles of 0.5% of the entire volume are put into the photo-curable resin and are agitated for about 10 minutes by an agitating rod. The fine particles are sufficiently de-foamed by leaving the fine particles for four or more hours after agitation. A clearance having a length of 50 mm, a width of 7 mm, and a depth of 1.05 mm is formed by surrounding the bottom surface and the side surface thereof with a metal plate, resin is poured into the clearance, and it is covered with a glass plate from above. In this case, air is prevented from entering the inside thereof. Thereafter, UV lamp irradiation is performed through glass to sufficiently cure resin. Thereafter, a product is taken out, is cut into a piece of the product having a width of 1.05 mm and a length of 4.15 m by a dicer (DAC552 manufactured by DISCO Corporation), and when it is intended to process the side surface thereof using the dicer, a blade is fed in a direction parallel to the length direction to process the product. This is for making the surface roughness of the side surface small in the light axis direction by causing a processing streak of the dicer to be generated along the length direction of the light integrator and reducing leakage of light from the light integrator. The side surface is processed using a dicing blade for a particle diameter of #5000 under a processing condition that the number of rotations is 30,000 rpm and a cutting speed is 0.5 mm/s and light input and output surfaces are processed using a dicing blade for a particle diameter of #3000 under a processing condition that the number of rotations is 30,000 rpm and a cutting speed is 0.5 mm/s. The surface roughness of the side surface in the light axis direction was Ra=0.3 μm, the surface roughness in a direction perpendicular to the light axis was Ra=1.0 μm, and the surface roughness of light input and output surfaces was Ra=2.0 μm.

When the side surface is enlarged and observed by a metallurgical microscope, in a cut surface, the medium 2 did not protrude from the side surface and the particles thereof are divided. In a non-cut side surface, the medium 2 was embedded into the medium 1 without protruding from the side surface.

As the light source, the LED (LTRB R8SF manufactured by OSRAM) is used. Three chips of red, green, and blue are mounted on a single LED and improvement of color reproducibility can be expected compared to a white LED.

As described above, in the present embodiment, the light integrator which is filled with the transparent material and homogenizes light emitted from the light source through total internal reflection is disposed between the light source and the light condensing body.

With this, the illumination device 82 can implement illumination light which is homogeneous and which color unevenness is not present in the illumination region 83. It is possible to efficiently condense light by using the light condensing body 61. There is an effect that color to be illuminated on the illumination region 83 can be adjusted.

### Embodiment 5

In the present embodiment, another example of the plural-wavelength light source 91 and the light integrator 93 of the illumination device 82 of Embodiment 4 will be described.

FIG. 9 is a diagram for explaining a plural-wavelength light source 122 in the present embodiment and FIG. 10 is a perspective view of a light integrator 123 in the present embodiment.

In FIG. 9, in the plural-wavelength light source 122, the first wavelength light source 96, the second wavelength light source 97, and the third wavelength light source 98 that respectively emit light having wavelength bands of red, green, and blue are linearly disposed in the inside of the portion formed with a width W_{LED} and a height H_{LED}. It is formed in a rectangle having a relationship of W_{LED}>H_{LED}.

In FIG. 10, the light integrator 123 is a quadrangular cylindrical shape having a length L, a height H, and a width W, but is formed in a rectangular sectional shape having a relationship of W>H. As such, in the present embodiment, the plural-wavelength light source 122 and the light integrator 123 are formed in a rectangle to be matched with the illumination region 83. With this, it is possible to more efficiently transmit light emitted from the rectangular light integrator 123 to the illumination region 83.

In general, it is known that a product of an area of the light source and brightness per unit cubic angle is saved. For that reason, when the aspect ratios of the light source, the light integrator, and the illumination region are matched with each other, transmission efficiency of light is improved.

### Embodiment 6

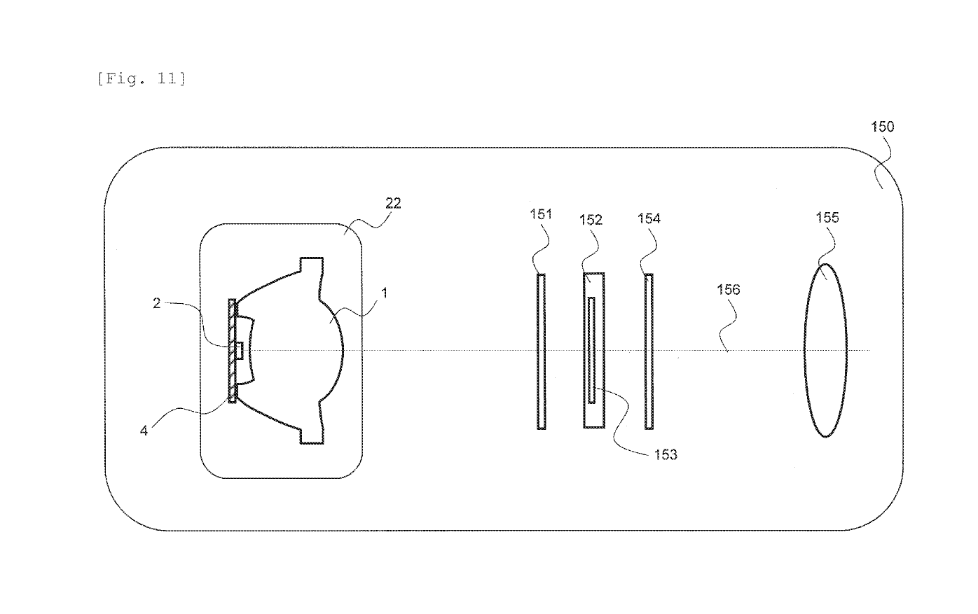

In the present embodiment, a video projection apparatus will be described. FIG. 11 is a cross-sectional view of a video projection apparatus 150 in the present embodiment. In FIG. 11, the video projection apparatus 150 includes the illumination device 22, polarization elements 151 and 154, a display device 152, and a projection body 155. A light advancing path 156 illustrated by a broken line is a virtual line illustrated in order to supplement description on advancing of the light beam.

A white light beam emitted from the light source 2 is illuminated on a display region 153 of the display device 152 by the light condensing body 1.

Light advances from the light condensing body 1 to the polarization element 151 before reaching the display device 152 and is selected as linearly polarized light in a predetermined direction.

Here, the display device 152 is assumed as a transmission type liquid crystal element with a color filter. The display region 153 of the display device 152 indicates a region in which video is generated.

The display region 153 has a function of converting predetermined polarized light into one of a vertical direction or a parallel direction to the polarized light for each pixel. When it is intended to validate video, it is converted into polarized light parallel to the direction selected by the polarization element 151.

Valid light beam and invalid light beam as the video advancing the display region 153 are incident on the polarization element 154. In the polarization element 154, only valid light beam as the video is passed through and invalid light beam of polarized light is absorbed or reflected.

Only the valid light beam as the video in the polarization element 154 advances to the projection body 155.

The projection body 155 is a projection lens and has a function of enlarging video of the display region 153 and forming the video on a screen or the human retina (not illustrated). In the figure illustrated, although a single projection body 155 is illustrated, a larger number of projection bodies may be adopted according to a projection distance or a magnification ratio of video to be projected.

It is preferable that the projection body 155 includes a mechanism which moves in the direction of withdrawing from the display device 152 or the direction of approaching the display device 152. By such mechanism, it is possible to have a focus function of changing an image-forming position of video according to the projection distance.

As described above, in the present embodiment, it is possible to implement a video projection apparatus which is obtained by using the illumination device described in Embodiment 1 and includes a display device generating video and a projection body projecting the video generated in the display device and of which transmission efficiency of light is good due to illumination of light, which is from the light condensing body, to the display device.

### Embodiment 7

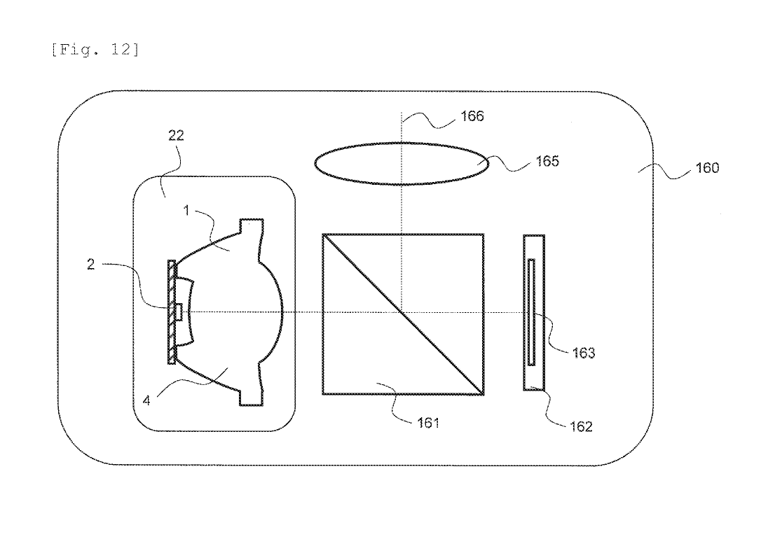

In the present embodiment, another example of the video projection apparatus 150 of Embodiment 6 will be described. FIG. 12 is a cross-sectional view of a video projection apparatus 160 in the present embodiment. In FIG. 12, the video projection apparatus 160 includes the illumination device 22 similar to Embodiment 6, a polarization branching element 161, a display device 162, and a projection body 165. A light advancing path 166 illustrated by a broken line is a virtual line illustrated in order to supplement description on advancing of the light beam.

A white light beam emitted from the light source 2 is illuminated on the display region 163 of the display device 162 by the light condensing body 1.

Light advances from the light condensing body 1 to the polarization branching element 161 before reaching the display device 162 and is selected as linearly polarized light in a predetermined direction. The polarization branching element 161 is assumed as a prism having polarization characteristic by a normal multilayer film.

The display device 162 is assumed as a reflection type liquid crystal element with a color filter (LCOS). The display region 163 of the display device 162 indicates a region in which video is generated.

The display region 163 has a function of converting predetermined polarized light into one of a vertical direction or a parallel direction to the polarized light for each pixel. When it is intended to validate video, it is converted into polarized light orthogonal to the direction selected by the polarization element branching 161.

Valid light beam and invalid light beam as the video advancing the display region 163 are incident on the polarization branching element 161 again. In the polarization branching element 161, only the valid light beam of polarized light as video is reflected and the invalid light beam of polarized light is passed through.

Only the valid light beam as the video in the polarization branching element 161 is allowed to advance to the projection body 165.

The projection body 165 is a projection lens and has a function of enlarging video of the display region 163 and forming the video on a screen or the human retina (not illustrated). In the figure, although a single projection body 165 is illustrated, a larger number of projection bodies may be adopted according to a projection distance or a magnification ratio of video to be projected.

It is preferable that the projection body 165 includes a mechanism which moves optically in the direction of withdrawing from the display device 162 or the direction of approaching the display device 162. By such mechanism, it is possible to have a focus function of changing an image-forming position of video according to the projection distance.

According to the present embodiment, the illumination device 22 is used so as to make it possible to implement the video projection apparatus 160 having good transmission efficiency of light.

### Embodiment 8

In the present embodiment, another example of the video projection apparatus 150 of Embodiment 6 will be described.

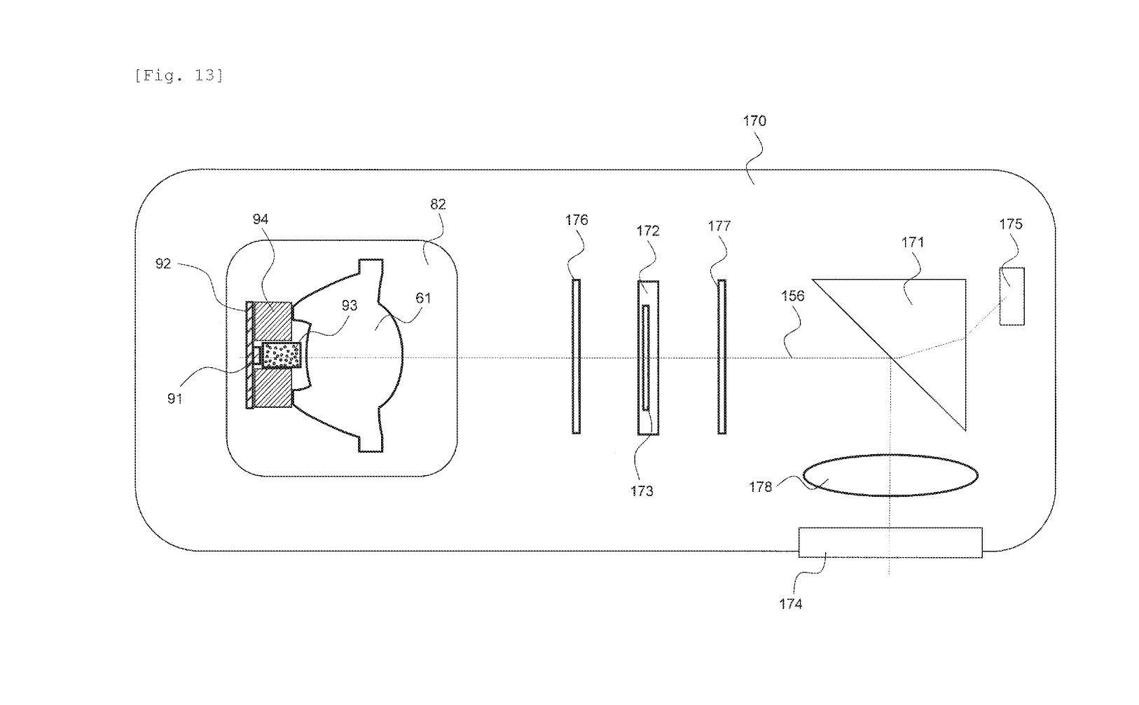

FIG. 13 is a cross-sectional view of a video projection apparatus 170 in the present embodiment. In FIG. 13, the video projection apparatus 170 includes an illumination device 82, polarization elements 176 and 177, a display device 172, and a projection body 178, a reflection body 171, an emission window 174, and a light detector 175. A light advancing path 156 illustrated by a broken line is a virtual line illustrated in order to supplement description on advancing of the light beam.

The illumination device 82 is the illumination device described in Embodiment 4 and includes the plural-wavelength light source 91, the light integrator 93, and the light condensing body 61. Light having three wavelengths emitted from the illumination device 82 advances to the polarization element 176 and is selected as linearly polarized light in a predetermined direction.

Light selected as polarized light in the predetermined direction in the polarization element 176 is illuminated on the display device 172.

Here, the display device 172 is assumed as a transmission type liquid crystal element without the color filter. For that reason, the number of pixels can be one third compared to that of a liquid crystal having the color filter and thus, video with high resolution can be implemented. The display region 173 of the display device 172 indicates a region in which video is generated. Colorization is implemented by the field sequential color technology that illuminates light having the wavelength bands of red, green, and blue present in the plural-wavelength light source 91 for each time.

The display region 173 has a function of converting predetermined polarized light into one of a vertical direction or a parallel direction to the polarized light for each pixel. When it is intended to validate video, it is converted into polarized light parallel to the direction selected by the polarization element 176.

Valid light beam and invalid light beam as the video advancing the display region 173 are incident on the polarization element 177. In the polarization element 177, only the valid light beam of polarized light as the video is passed through and the invalid light beam of polarized light is absorbed or reflected.

Only the valid light beam as video in the polarization element 177 is reflected on the reflection body 171 and is allowed to advance to the projection body 178.

The reflection body 171 has a function of bending video. The prism as illustrated can be implemented by a simple reflection mirror or the like. It is preferable to secure surface accuracy of a surface through which the light beam passes so as not to allow video to be distorted.

The projection body 178 is a projection lens required to include a plurality of lenses and has a function of enlarging video of the display region 173 and forming the video on a screen or the human retina (not illustrated). In FIG. 13, although a single group is illustrated, a larger number of projection bodies may be adopted according to a projection distance or a magnification ratio of video to be projected.

It is preferable that the projection body 178 includes a mechanism which moves optically in the direction of withdrawing from the display device 172 or the direction of approaching the display device 172. By such mechanism, it is possible to have a focus function of changing an image-forming position of video according to the projection distance.

Light emitted from the projection body 178 is projected to the screen or the human retina (not illustrated) via the emission window 174.

The emission window 174 has a function of preventing dirt, water drops, or the like from entering from the outside. It is preferable to form an antireflective film which is an optically transparent flat plate and is for a region from red to blue (range from a wavelength of 430 nm to a wavelength of 670 nm) so that loss of efficiency is reduced.

In the video projection apparatus 170, the light detector 175 is mounted and light emitted from the plural-wavelength light source 91 can be detected. An initial value of light emitted from the plural-wavelength light source 91 is stored by the light detector 175 and it is configured to be able to perform feedback control when the light amount is changed due to temperature or temporal degradation.

As another configuration thereof, a configuration in which the projection body 178 is provided between the polarization element 177 and the reflection body 171, only the valid light beam as video in the polarization element 177 is allowed to advance to the projection body 178, and light emitted from the projection body 178 is reflected on the reflection body 171 and is projected to the screen or the human retina via the emission window 174 may be available.

### Embodiment 9

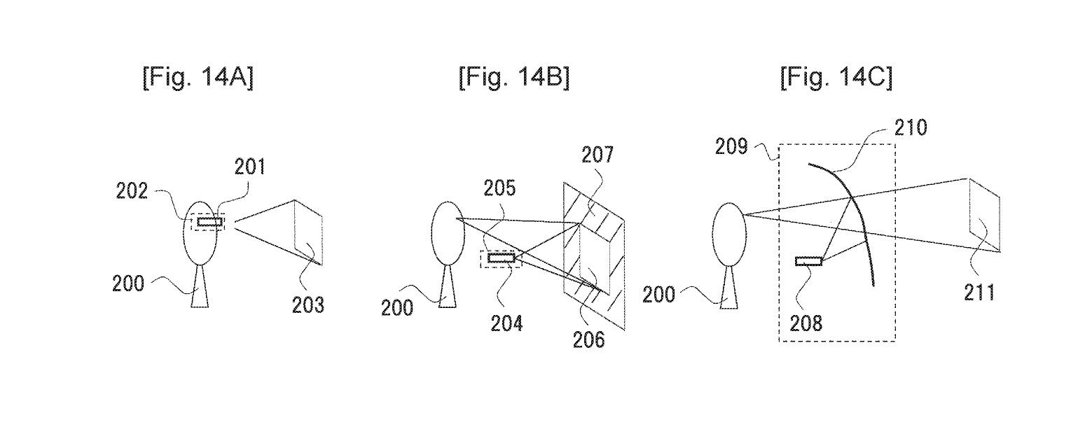

In the present embodiment, an application example of the video projection apparatus will be described. FIG. 14 is a diagram for explaining an application example of the video projection apparatus in the present embodiment. In FIG. 14, FIG. 14(A) illustrates an example of an HMD 202, FIG. 14(B) illustrates an example of a small projector 205, and FIG. 14 (C) illustrates an example of an HUD 209.

In FIG. 14(A), the HMD 202 is mounted on the head of a user 200 and video is projected to the eyes of the user 200 from the video projection apparatus 201 mounted inside the HMD 202. The user is able to visually recognize a virtual image 203 which is video as if it is floating on air.

In FIG. 14(B), in the small projector 205, video 206 is projected from the video projection apparatus 204 mounted inside thereof to a screen 207. The user 200 can visually recognize video imaged in the screen as an actual image.

In FIG. 14 (C), in the HUD 209, video is projected from a video projection apparatus 208 mounted inside thereof to a virtual image generating element 210. The virtual image generating element has a beam splitter function of transmitting a portion of light beams and reflecting remaining light beams, has a curved surface structure, and has a lens function of generating a virtual image by directly projecting video to the eyes of the user 200. The user 200 can visually recognize a virtual image 211 which is video as if it is floating on air. An application of such HUD to an assist function for a vehicle driver, a digital signage, and the like can be expected.

In any apparatus, a video projection apparatus which is small and bright is preferable. The video projection apparatus described in the present embodiment can contribute to miniaturization or improvement of brightness.

### Embodiment 10

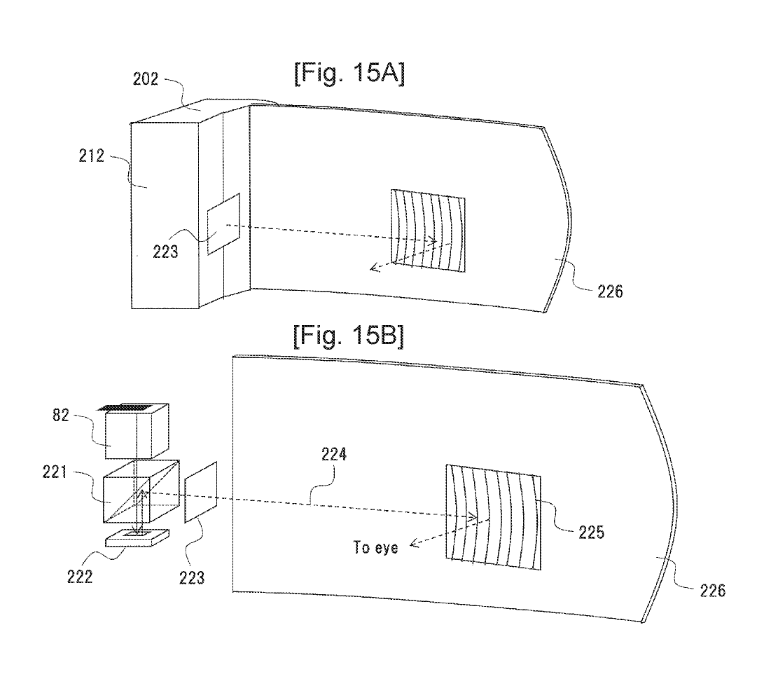

In the present embodiment, the HMD using the video projection apparatus described in Embodiments 6 to 8 will be described. FIG. 15 is a diagram for explaining an HMD 202 in the present embodiment. FIG. 15(A) is a perspective view of the HMD 202 and includes a video projection apparatus 212, an emission window 223, and a projection body 226. FIG. 15(B) is a perspective view illustrating inside the video projection apparatus 212 by making transparent for explanation. The video projection apparatus 212 includes the illumination device 82, a polarization branching element 221, and a display device 222. Alight advancing path 224 illustrated by a broken line is a virtual line illustrated in order to supplement description on advancing of the light beam.

In FIG. 15(B), light emitted from the illumination device 82 and having three wavelengths advances to the polarization branching element 221 and is selected as linearly polarized light in a predetermined direction.

Light selected as polarized light in the predetermined direction in the polarization branching element 221 is illuminated on the display device 222.

Here, the display device 222 is assumed as a transmission type liquid crystal element without a color filter. For that reason, the number of pixels can be one third compared to that of a liquid crystal having the color filter and thus, video with high resolution can be implemented. The display region of the display device 222 indicates a region in which video is generated. Colorization is implemented by the field sequential color technology that illuminates light having the wavelength bands of red, green, and blue present in the plural-wavelength light source 91 (not illustrated) in the illumination device 82 for each time.

The display region has a function of converting predetermined polarized light into one of a vertical direction or a parallel direction to the polarized light for each pixel. When it is intended to validate video, it is converted into polarized light orthogonal to the direction selected by the polarization branching element 221.

Valid light beam and invalid light beam as the video advancing the display region are incident on the polarization branching element 221 again. In the polarization branching element 221, only the valid light beam of polarized light as the video is reflected and the invalid light beam of polarized light is passed through.

Only the valid light beam as the video in the polarization branching element 221 is allowed to advance to the projection body 226 via the emission window 223.

A hologram 225 is formed in a portion of the projection body 226 and the projection body 226 has a function of forming video of the display region on the eyes as the virtual image.

The hologram 225 is a diffraction element and is known that it can reflect a portion of incident light beams to apply a predetermined phase to the reflected light beam. The hologram 225 has a lens function of using the phase.

The projection body 226 is formed in a plate shape like eyeglasses and is fixed to a mechanism of the video projection apparatus 212. For that reason, the projection body 226 has a function of connecting a mechanism including the illumination device 82 and the hologram 225. The projection body 226 may be hard-coated to prevent oil from being stuck.

A multilayer film for preventing external light from entering may be formed in the projection body 226 in order to improve contrast of video. A configuration in which transmittance is changed according to brightness of external light is preferable. Such function can be implemented by a liquid crystal shutter, a light control glass, or the like.

The emission window 223 has a function of preventing dirt, water drops, or the like from entering from the outside. It is preferable to form an antireflective film which is optically transparent flat plate and is for a region from red to blue (range from a wavelength of 430 nm to a wavelength of 670 nm) so that loss of efficiency is reduced.

The video projection apparatus 212 may have a configuration in which the light detector is mounted thereon, light emitted from the plural-wavelength light source 91 is detected, and feedback control can be performed when the light amount is changed due to temperature or temporal degradation.

As described above, in the present embodiment, the video projection apparatus which is obtained by using the illumination device described in Embodiment 1 includes a display device generating video and a projection body projecting the video generated in the display device and in which light from the light condensing body is illuminated on the display device and the projection body optically diverges video to be projected from the video projection apparatus so that the user can visually recognize the virtual image. With this, it is possible to implement the video projection apparatus which projects the virtual image and which has good transmission efficiency of light.

### Embodiment 11

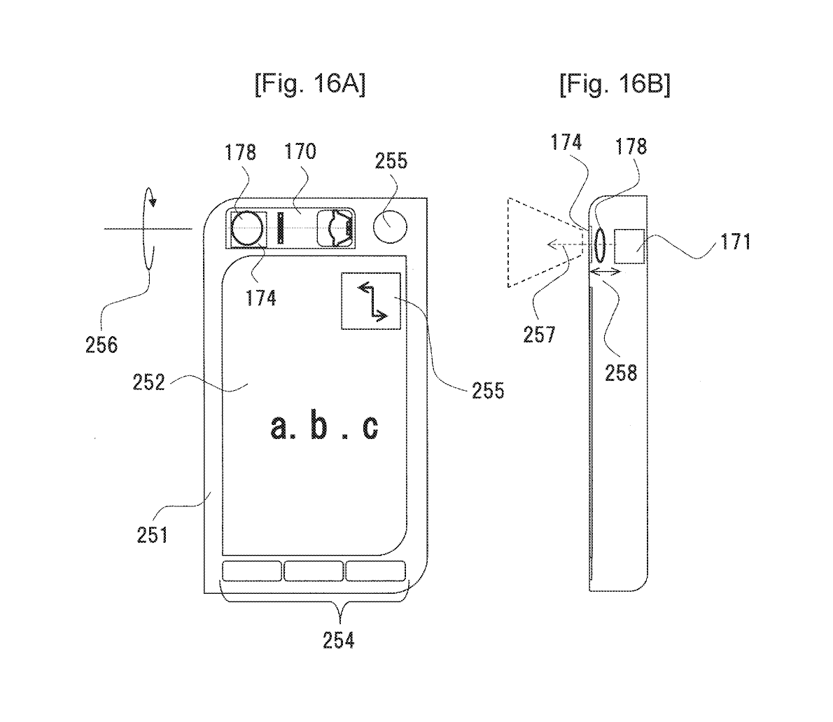

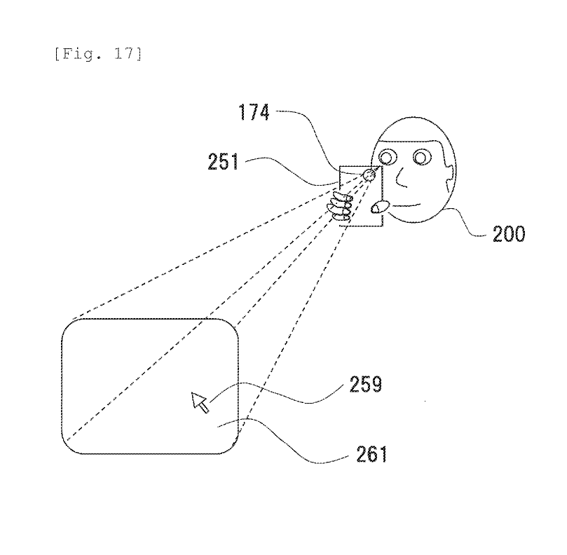

In the present embodiment, a smartphone using the video projection apparatus described in Embodiments 6 to 8 will be described. FIG. 16 is a diagram for explaining a smartphone 251 in the present embodiment. FIG. 16(A) illustrates a front view and FIG. 16(B) illustrates a side view.

In FIG. 16(A), the smartphone 251 includes an operation device having display function 252 which has two functions of displaying and operating by fingers using an electrostatic capacity, an operation button 254 for control, an image-capturing device 255 photographing the outside, and the video projection apparatus 170.

As illustrated in FIG. 16(B), the video projection apparatus 170 can project the virtual image in an arrow 257 direction. The video projection apparatus 170 includes a projection body 178, a reflection body 171, and an emission window 174. The projection body 178 includes a mechanism 258 which moves in the direction of withdrawing from the reflection body 171 or the direction of approaching the reflection body 171 so as to make it possible to have a focus function of changing an image-forming position of video according to the projection distance.

As illustrated in FIG. 16(A), the video projection apparatus 170 may be available as long as it is provided with a rotating mechanism (not illustrated) capable of being rotated in an arrow 256 direction and a direction to which video is projected can be selected in an upper side and a rear side.

As such, it is preferable that the entirety of an apparatus is miniaturized in order to implement such an apparatus for mobile use. High utilization efficiency is required in order to make a battery last to be used. In the present embodiment, the video projection apparatus 170 can implement such needs.

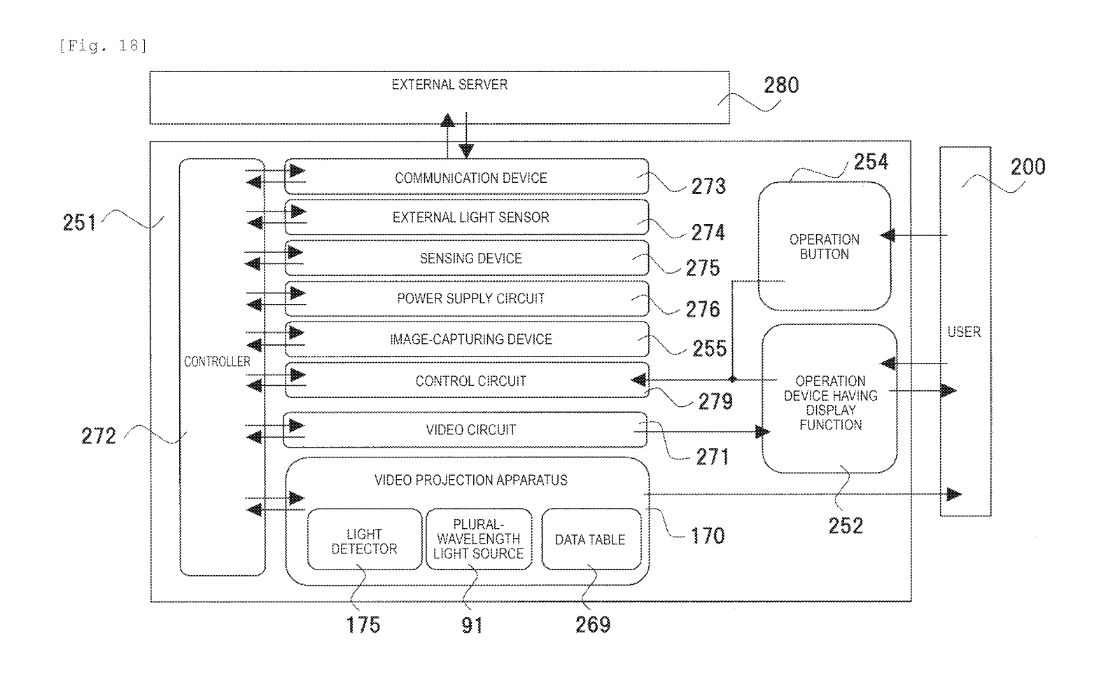

FIG. 17 is a diagram for explaining a usage scene of the smartphone 251. When the user 200 views through the emission window 174 of the smartphone 251, the user 200 can visually recognize a virtual image 261 generated by the video projection apparatus 170.

The video projection apparatus 170 is mounted on the smartphone 251 so as to make it possible to simultaneously view the virtual image 261 as well as video of the operation device having display function 252 of the smartphone 251. The effect that a size of the virtual image 261 can be larger than a size of a display area of the smartphone is obtained.

In recent years, there is needs to view large video by the smartphone and increase in an area in which video is displayed is progressing. However, there is also needs to select a small smartphone by placing importance on portability. In the present embodiment, though the smartphone 251 is small, video can be large and thus, it is possible to satisfy both needs.

A normal smartphone can be operated by the fingers. The operation of the fingers on the operation device having display function 252 is displayed as a pointer 259 on video so as to make it possible for the user 200 to operate while viewing the video 261. In this case, control may be performed by placing an icon, which causes switching between the operation for making video on the operation device having display function 252 operate and the operation for making the video 261 operate, on the operation device having display function 252. Also, control may be performed by the operation button 254.

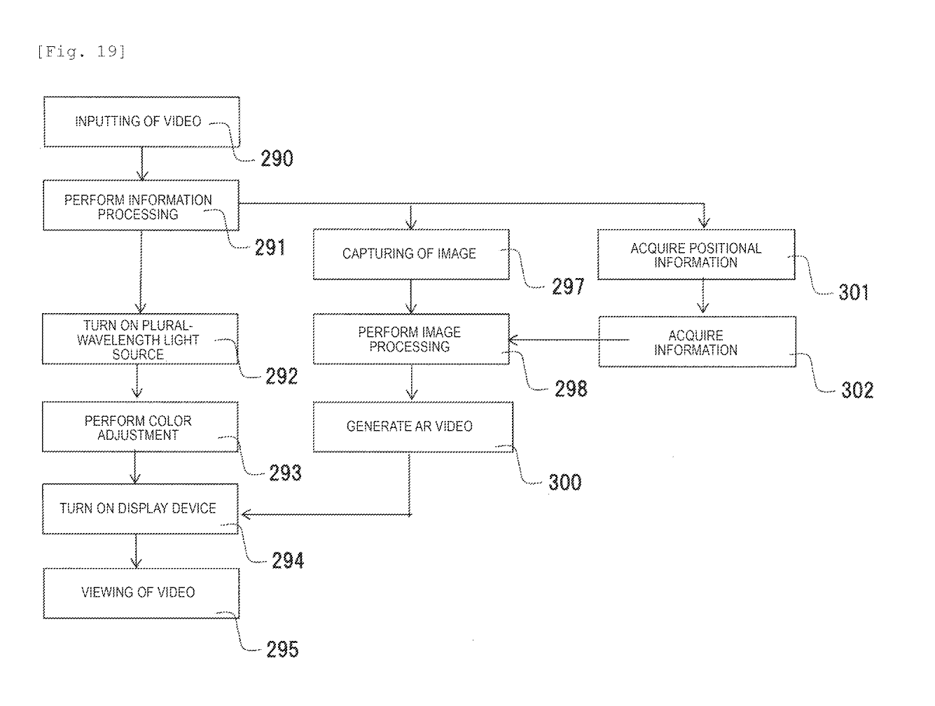

FIG. 18 is a diagram for explaining a system of the smartphone 251. In FIG. 18, the smartphone 251 includes the video projection apparatus 170 which includes a light detector 175, a plural-wavelength light source 91, and a data table 269 storing a setting value for controlling the plural-wavelength light source, a controller 272, a communication device 273, an external light sensor 274, a sensing device 275, a power supply circuit 276, an image-capturing device 255, a control circuit 279, a video circuit 271, an operation button 254, and the operation device having display function 252.

The communication device 273 has a function of acquiring information on the Internet such as the Wi-Fi (registered trademark) or Bluetooth (registered trademark) or external information by accessing an external server 280 such as an electronic device possessed by the user 200. The external light sensor 274 has a function of acquiring brightness of the outside. A scanning device having display function 252 has a function of displaying information to the user 200 and acquiring operation information operated by using the fingers. The sensing device 275 has a function that senses an external environment by an acceleration sensor which detects acceleration using a principle such as a piezoelectric element or an electrostatic capacitance, the GPS, or the like. The power supply circuit 276 has a function of supplying power from a battery or the like. The image-capturing device 255 has a function of acquiring external field video by a camera or the like. The control circuit 279 has a function of detecting information that the user 200 intends to operate from the operation button 254 or the operation device having display function 252. The video circuit 271 has a function of converting video information into information for the operation device having display function 252 or the video projection apparatus 170 according to the operation of the user 200. The controller 272 is a main chip that controls individual apparatuses and circuits according to information obtained from the control circuit 279 and operated by the user 200.

For example, the controller 272 has a function that detects a place where the smartphone 251 is disposed, selects surrounding information from the external server 280, drives the video projection apparatus 170 or the operation device having display function 252, and displays selected information to the user 200 as video, based on information obtained from the sensing device 275.

The power supply circuit 276 supplies power required for an apparatus through the controller 272. In this case, it is preferable that the controller 272 has a function of supplying power to only the necessary apparatus and circuit so as to save power according to necessity.

It is preferable that the controller 272 has a function of monitoring information of a light amount from the light detector 175 within the video projection apparatus 170 and controlling the output of the plural-wavelength light source 91.

The controller 272 also has a function that when information generated from the operation of the icon of the operation device having display function 252 is sent from the control circuit, performs an operation for displaying a pointer on video by the video circuit, and operates the video apparatus 170.

FIG. 19 is a diagram for explaining an operation flow of the smartphone 251. Here, an operation flow for viewing video obtained by applying virtual reality (hereinafter, denoted by AR) to video captured by the image-capturing device 255 will be described.

In FIG. 19, the user 200 inputs an AR video by the operation device having display function 252 (290 in the figure). The controller 272 acquires operational information from the control circuit 279 and performs required information processing (291 in the figure). The controller 272 drives the plural-wavelength light source 91 to emit light (292 in the figure). The controller 272 uses a signal of the light detector 175 to perform color adjustment based on information of the data table (293 in the figure).

The controller 272 operates the plural-wavelength light source 91 and acquires external field video by the image-capturing device 255 at the same time (297 in the figure). The controller 272 acquires positional information of the user 200 by the sensing device 275 (301 in the figure) and acquires external information from the external server 280 by the communication device 273 (302 in the figure).

The controller 272 drives the video circuit 271 and performs image processing on external information or external field video information (298 in the figure) so as to generate voice or an AR video (300 in the figure). The generated AR video is projected by the display device (294 in the figure). The user 200 views the video (295 in the figure).

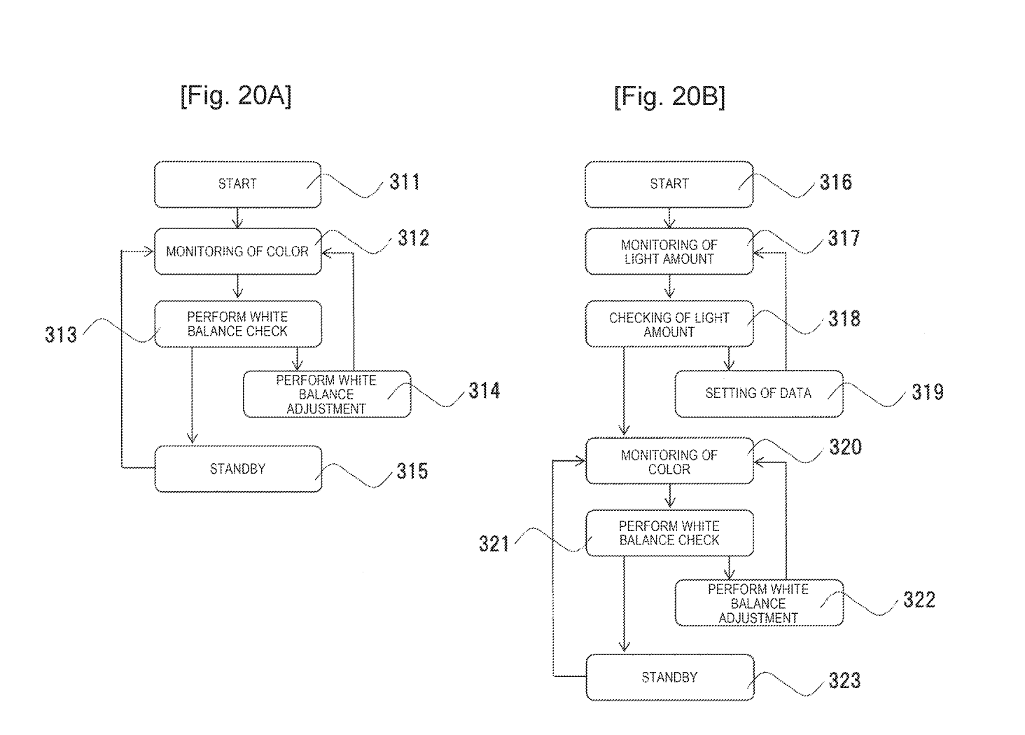

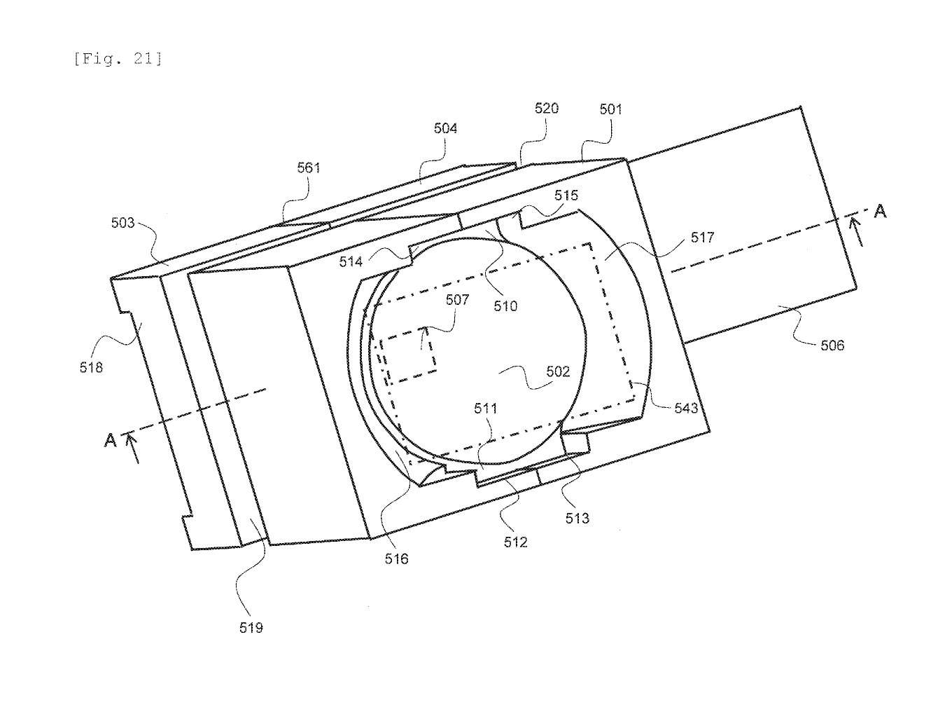

Next, an adjustment flow of the plural-wavelength light source 91 of the video projection apparatus 170 will be described using FIG. 20. FIG. 20(A) is a flow of color adjustment flow.

In FIG. 20(A), first, at the time of setting initial values before shipment, light amounts I0(R), I0(G), and I0(B) having wavelength bands of red, green, and blue of the plural-wavelength light source 91 are stored in the data table 269 so that images emitted from the video projection apparatus 170 correspond to designated color coordinates. When an instruction to perform video proj ection of the video proj ection apparatus 170 is received from the controller 272, the video projection apparatus 170 starts emitting light of the plural-wavelength light source 91 (311 in the figure). Next, light amounts I1(R), I1(G), and I1(B) of the plural-wavelength light source 91 are detected by the light detector 175 (312 in the figure). The detected light amounts I1(R), I1(G), and I1(B) and the initial light amounts I0(R), I0(G), I0(B) are compared with each other so as to check whether there is no error in the designated color coordinates (313 in the figure).

As long as the video projection apparatus 170 is being operated, in a case where the error of the color coordinates is not present, the adjustment flow in which a predetermined time passes (315 in the figure) and the light amount is detected by the light detector 175 again (313 in the figure) is repeated.

The semiconductor light source such as the LED has characteristics that an output varies with temperature. For that reason, a light output having respective colors and emitted from the plural-wavelength light source 91 varies due to a temperature change in environment, heating of an electronic circuit disposed in the vicinity of the plural-wavelength light source 91, or the like. Ina case where the output is varied, the light amounts of the first wavelength light source 96, the second wavelength light source 97, and the third wavelength light source 98 within the plural-wavelength light source 91 are controlled so that the error is corrected (314 in the figure). Control of the light amount can be implemented by a method for changing a driving current, a method for changing a light emission time, or the like.

After the completion of adjustment of light amount control, the light amount is detected again (312 in the figure) and it is checked whether the light amount corresponds to a predetermined color (313 in the figure).

As such, it is preferable that the video projection apparatus 170 performs a feedback control so that the color coordinates do not exceed a fixed range.

It is assumed that the light integrator 93 is resin. For that reason, it is assumed that transmittance is lowered by degradation with time or degradation due to receiving of ultraviolet ray or the like. It is also assumed that the plural-wavelength light source 91 is degraded with time to lower a light amount itself of light to be emitted. For such a case, a method for performing brightness control will be described using FIG. 20(B).

In FIG. 20(B), the video projection apparatus 170 receives an instruction to perform video projection of the video projection apparatus 170 from the controller 272 and starts emitting light of the plural-wavelength light source 91 (316 in the figure). Next, light amounts I2(R), I2(G), and I2(B) of the plural-wavelength light source 91 are detected by the light detector 175 (317 in the figure). A sum IT2 of the detected light amounts I2(R), I2(G), and I2 (B) are compared with a sum IT0 of the initial light amounts I0(R), I0(G), and I0(B) (318 in the figure).

In a case where the difference in the light amount is smaller than a predetermined setting value, it is assumed that either of the plural-wavelength light source 91 or the light detector 93 is degraded, and the initial light amounts I0(R), I0(G), and I0(B) are changed to light amounts I0 [symbol] (R), I0 [symbol] (G), and I0 [symbol] (B) according to a ratio between the IT2 and the IT0 to update the setting values of the data table 269 (319 in the figure).

After the update of the setting value, the light amounts I2(R), I2(G), and I2(B) of the plural-wavelength light source 91 are detected again by the light detector 175 (317 in the figure). The sum IT2 of the detected light amounts I2(R), I2(G), and I2(B) is compared with a sum IT0 [symbol] of the initial light amounts I0 [symbol] (R), I0 [symbol] (G), and I0 [symbol] (B) (318 in the figure).

In a case where it is confirmed that the difference of the light amount is within a range of the predetermined setting value, next, light amounts I3(R), I3(G), and I3(B) are detected by the light detector 175 (320 in the figure). The detected light amounts I3(R), I3(G), and I3(B) and the reset initial light amounts I0 [symbol] (R), I0 [symbol] (G), and I0 [symbol] (B) are compared with each other so as to check whether there is no error in the designated color coordinates (321 in the figure).

As long as the video projection apparatus 170 is being operated, in a case where the error of the color coordinates is not present, the adjustment flow in which a predetermined time passes (323 in the figure) and the light amount is detected by the light detector 175 again (320 in the figure) is repeated.

In a case where an error is present in the output of the light amount, the light amounts of the first wavelength light source 96, the second wavelength light source 97, and the third wavelength light source 98 within the plural-wavelength light source 91 are controlled so that the error is corrected (322 in the figure).

After the completion of adjustment of light amount control, the light amount is detected again (320 in the figure) and it is checked whether the light amount corresponds to predetermined color coordinates (321 in the figure). Variation in brightness due to degradation with time can be corrected by performing the check on variation in brightness only at the time of activation and thus, a flow from 320 to 323 in the figure may be repeated to control the light amount, at the time except for the time of activation.

As described above, as illustrated in FIG. 20 (B), color and brightness are also monitored so as to make it possible to avoid a defect that the color coordinates cannot be adjusted due to decrease of brightness caused by degradation with time.

### Embodiment 12

In the present embodiment, an illumination device having a configuration different from Embodiments 1 to 4 will be described.

FIG. 21 is a perspective view of an illumination device 501 in the present embodiment. The illumination device 501 is configured to include a lens 502, reflector cases 503 and 504, a light integrator 507, a plural-wavelength light source 508, and a flexible light source substrate 506.

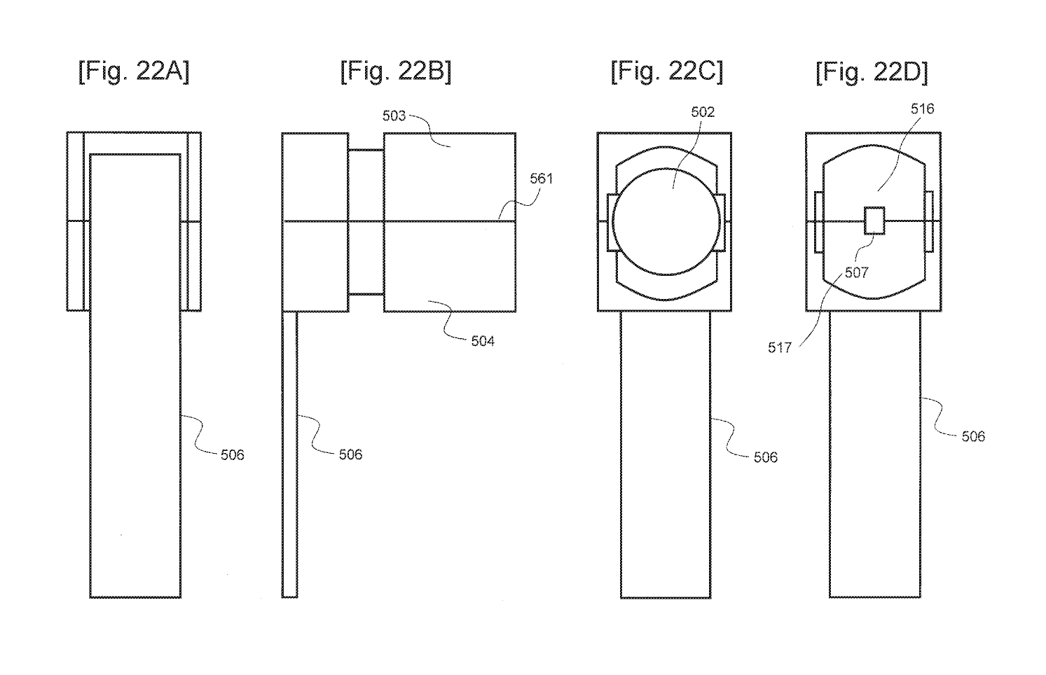

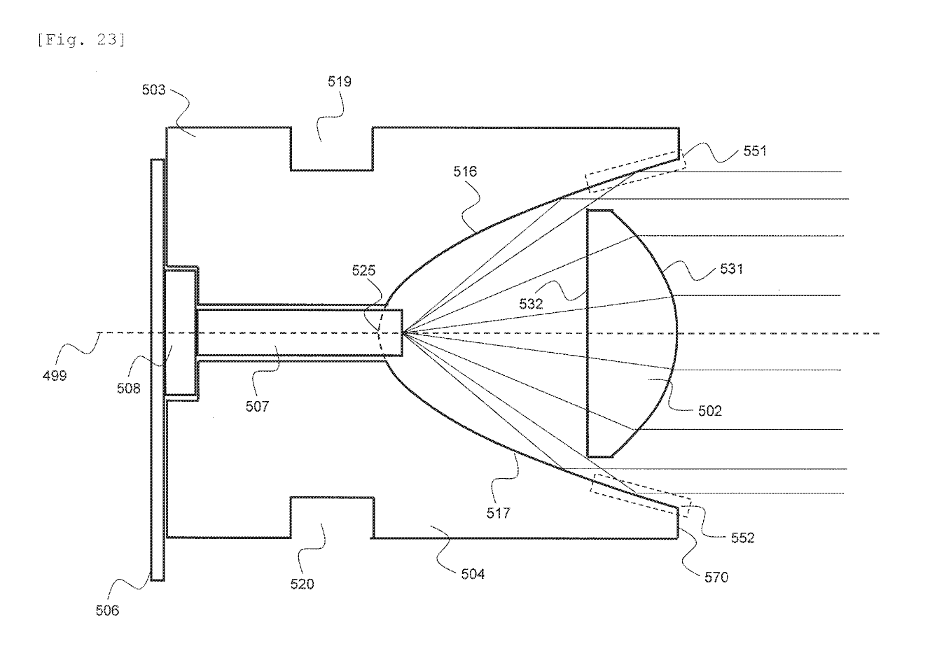

FIG. 22 is a development view of the illumination device 501 in the present embodiment. When an emission light side of the illumination device 501 is set as the front, FIG. 22 (A) is a rear view when seen from the flexible light source substrate 506 side, FIG. 22(B) is a side surface, FIG. 22 (C1) is a front view when seen from the lens 502 side, and FIG. 22 (C2) is a front view in a case where the lens 502 is removed. As illustrated in FIG. 22, the reflector cases 503 and 504 are stuck by the boundary 561, guide light from the light source, and hold the lens 502, as will be described later.

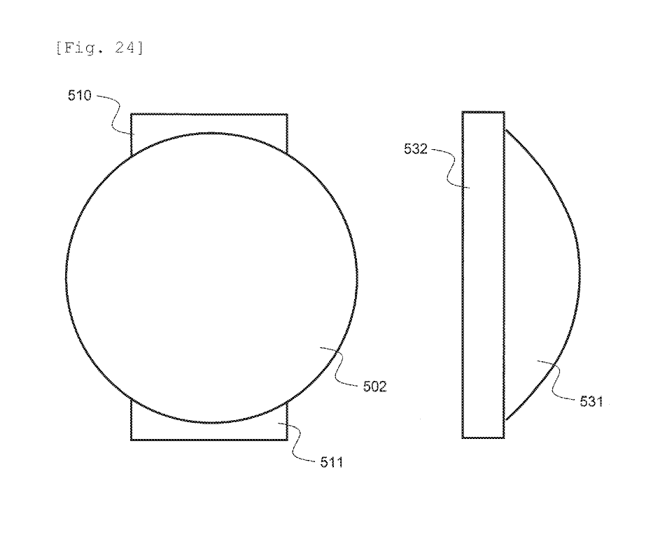

FIG. 23 is a cross-sectional view of the illumination device 501 in the present embodiment and illustrates a cross-sectional view when seen from an arrow direction in A-A line of FIG. 21.

Similar to the plural-wavelength light source 91 described above, the plural-wavelength light source 508 is a surface emission type light source emitting three wavelengths and here, the plural-wavelength light source 508 is also assumed as the LED provided with chips of wavelength bands of red, green, and blue. The flexible light source substrate 506 is so-called a flexible printed board and can be used for electrical joining with the outside. The plural-wavelength light source 508 is mounted on the flexible light source substrate 506 and can supply the current from the outside through the flexible light source substrate 506.

Light emitted from the plural-wavelength light source 508 is incident on the light integrator 207 to be uniformly color-mixed. Similar to the light integrator 93 described above, the light integrator 507 is filled with the scattering elements (not illustrated) in a random manner and can efficiently mix colors of light by a scattering function and a function of trapping light into the inside by the side surfaces.

As illustrated in FIG. 23, light emitted from the light integrator 507 is illuminated on the illumination region 543 illustrated in FIG. 21 through the lens 502 or reflection parabolic surfaces 516 and 517 of the reflector cases 503, 504. It is assumed that the illumination region 543 is a rectangle having aspect ratio of 16:9 which is general for a display device.

The reflection parabolic surfaces 516 and 517 are present in the reflector cases 503 and 504, respectively. When the parabolic line is set as y=ax̂2 (hat 2), it is assumed that both the reflection parabolic surfaces 516 and 517 have the same coefficient and origin. That is, a focus on the parabolic line is disposed on the emission surface of the light integrator 525 and the origin of the parabolic line is set as a point 525. For that reason, light emitted from the light integrator 507 is converted into substantially parallel light by the parabolic surfaces 516 and 517.

The reflection parabolic surfaces 516 and 517 are also surfaces reflecting light and are preferably implemented by the dielectric multilayer film in order to implement high reflectance. It may be coated with metal such as aluminum or silver.

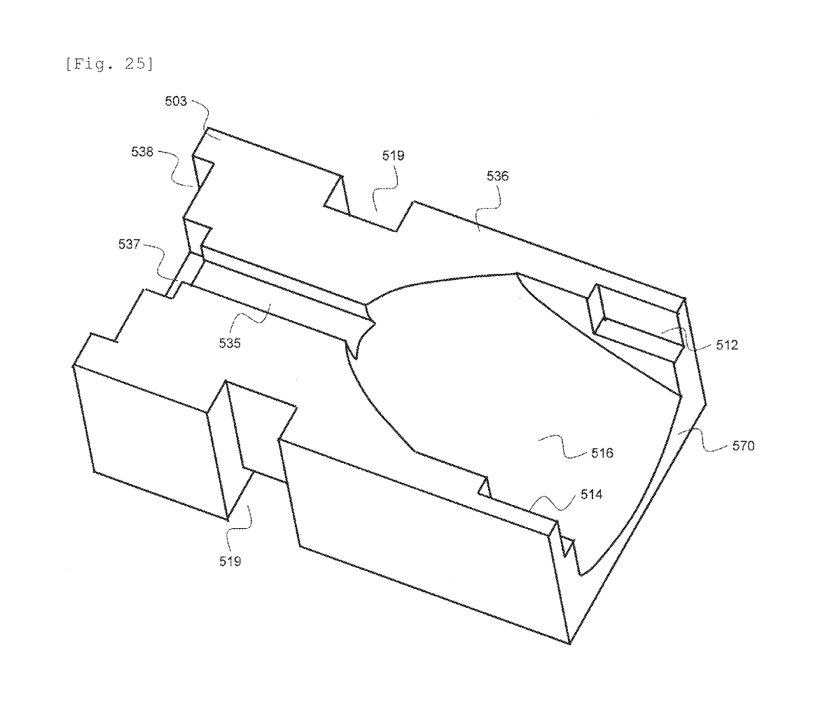

FIG. 24 is a development view of the lens 502 and illustrates a front view and a side view. As illustrated in FIG. 24, the lens 502 is an optical convex lens molded with a transparent material and has a function of converting light emitted from the light integrator 507 into substantially parallel light. It is preferable that a flat surface 532 which is an incidence surface of the lens 502 and a lens surface 531 which is an emission surface are subjected to antireflection coating. It is preferable that the focus of the lens 502 is substantially coincident with the emission surface of the light integrator 525 and the lens surface 531 is formed in an aspherical shape so that light of the emission surface of the light integrator 525 can be efficiently made parallel to each other.

The lens 502 includes collars 510 and 511 at a portion of the outside of the lens surface 531 in order to be fixed.

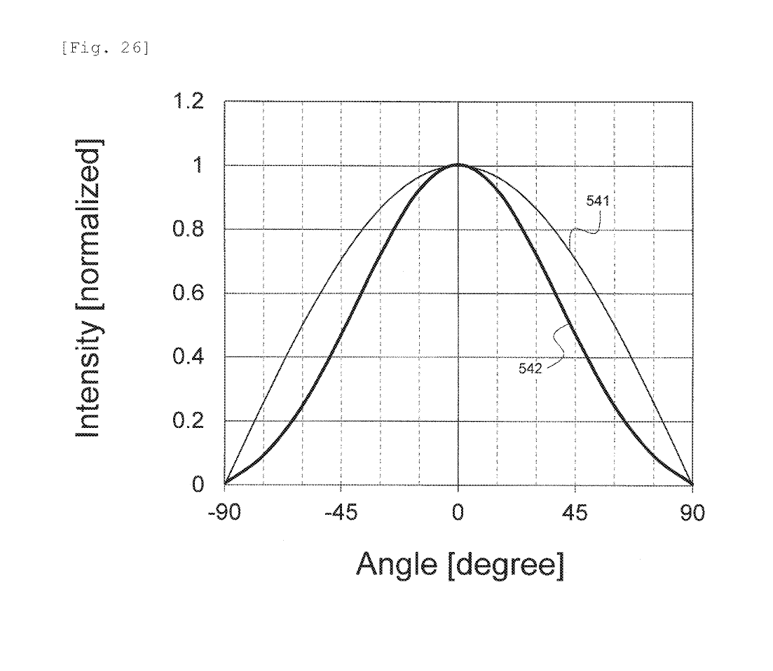

FIG. 25 is a perspective view of the reflector case 503. The reflector cases 503 and 504 have the same shape and are stuck together symmetrically in the surface 536. For that reason, the boundary 561 in FIGS. 21 and 22 indicates a boundary at the time of sticking reflector cases together.

It is preferable that the reflector cases 503 and 504 are non-transparent material that at least shields light. The reflector cases 503 and 504 are preferably resin in order to reduce its weight. For example, it can be easily implemented by black-colored polycarbonate or the like.

The reflector cases 503 and 504 have not only an optical function called the reflection parabolic surface described above but the function as cases that fix the lens 502, the light integrator 507, the plural-wavelength light source 508, and the flexible light source substrate 506. The reflector cases 503 and 504 include support mechanisms 512 and 514 for the lens 502, a support mechanism 535 for the light integrator 507, a support mechanism 537 for the plural-wavelength light source 508, and a support mechanism 538 for the flexible light source substrate 506.

The lens 502 is fixed to the support mechanisms 512, 513, 514, and 515 included in the respective reflector cases 503 and 504 through the collars 510 and 511 of the lens 502 described above. That is, as is evident from FIGS. 23 and 25, it is configured in such a way that lens 502 is disposed within space forming the reflection parabolic surfaces 516 and 517 and light, which was not converted into substantially parallel light and not captured by the lens, of light color-mixed in the lens, are converted into substantially parallel light by the reflection parabolic surfaces 516 and 517.

In the case of aspect ratio 16:9 (horizontal:vertical) of the display device, a vertical side is short. Accordingly, the collars 510 and 511 are provided to be substantially parallel to the vertical side. In this case, when a horizontal cross section of the illumination device 23 is viewed like FIG. 23, the lens 502 is seen as if it is being floated. Light emitted from the light integrator 507 can be effectively utilized in a range extending to areas 551 and 552 of the reflection parabolic lines 516 and 517 which are closer to the light-emitting direction side than the lens. The greater the amount of light which is substantially parallel to be emitted, the greater the efficiency of the illumination device for the video projection apparatus which projects the virtual image and of which the capturing angle of light is limited can be. The support mechanism 519 is provided to be used for positioning the illumination device 501 when the illumination device 501 is intended to be mounted on another virtual image device.

FIG. 26 is a graph illustrating intensity in the vertical axis with respect to an emission angle of the horizontal axis of light emitted from a light integrator. The vertical axis is normalized by intensity when the angle is zero. Normally, light emitted from the surface emission type light source advances in all directions. For that reason, light emitted from the plural-wavelength light source 508 also advances toward the front as represented by the line 541. Among light emitted from the light integrator 507, light of which the emission angle range is large is converted to light of which the emission angle range is small and thus, as illustrated by the line 542, a gap between ridges in angular intensity distribution becomes narrower. In a case where the light integrator 507 is used, light of a small angle is increased and thus, it may be said that when efficiency of light of the small angle is increased rather than light of a wide angle, it is possible to uniformize the illumination region 543.

For that reason, as described above, a configuration in which the lens 502 is disposed within space forming the reflection parabolic surfaces 516 and 517 is adopted and light of a small angle is captured into the illumination region 543 as parallel light by the lens 502 and escaping light is also captured as substantially parallel light in the areas 551 and 552 so as to make it possible to effectively use light. That is, in a case where the illumination device 501 is combined with the light integrator 507, it is possible to obtain effect capable of further enhancing efficiency.

The reflection parabolic surface of the reflector case may be formed in an elliptical shape in which the focuses are present on four corners of the illumination region as described in Embodiment 1 and the emission surface of the light integrator 507. In this case, efficiency of brightness at four corners is further enhanced.

Although the flat surface 532 is used as the incidence surface and the lens surface 531 is used as the emission surface in the lens 502, in contrast, the lens surface may be used as the incidence surface and the lens surface may be used as the emission surface. Also, the lens surface may be used as both the incidence surface and the emission surface.

In the reflector case 503, the support mechanism 535 for the light integrator 507 may also be subjected to reflection coating. In this case, the effect that light which is leaked without being trapped in the light integrator 507 is recycled can be obtained. As described above, the reflector case 503 is divided and thus, the effect that the reflection parabolic surface 516 and the support mechanism 535 are subjected to reflection coating at the same time can be obtained.

As described above, the illumination device of the present embodiment includes the light source (for example, the plural-wavelength light source 508), the light integrator (for example, light integrator 507) which is filled with a transparent material and homogenizes light emitted from the light source through total internal reflection, the lens (for example, lens 502) converting light emitted from the light integrator into substantially parallel light, and the reflection parabolic surface (for example, reflection parabolic surfaces 516 and 517) which is disposed at the outside of the lens with respect to the light axis center (broken line 499) of the lens and converts light emitted from the light integrator to substantially parallel light and in the illumination device, the scattering element which scatters light is included in the inside of the light integrator and the surface of the light integrator side (for example, flat surface 532) of the lens is disposed on a side closer to a light integrator side than an end (for example, surface 570) in the light axis direction of the lens which is located at a side opposite to the light integrator of the reflection parabolic surface.

An illumination method of an illumination device, which includes a reflection parabolic surface, which color-mixes light emitted from a light source converts color-mixed light into substantially parallel light, and a lens and condenses light emitted from the light source to be emitted, and light, which was not converted into substantially parallel light by the lens disposed within space which forms the reflection parabolic surface, is converted into substantially parallel light by the reflection parabolic surface.

With this, it is possible to implement the illumination device capable of efficiently illuminating light from the light source on the illumination region.

Until now, although the embodiments of the invention are described, the invention is not limited to the embodiments described above, but includes various modification examples. For example, the examples described above are described in detail in order to make the invention easier to understand and is not necessarily limited to an embodiment in which all configuration described are included. Also, it is possible to replace a portion of a configuration of an embodiment with a configuration of another embodiment and it is possible to add a configuration of another embodiment to a configuration of a certain embodiment. Also, it is possible to add, delete, and replace of a configuration of another configuration, with respect to a portion of a configuration of a certain embodiment.

### REFERENCE SIGNS LIST

1: light condensing body
2: light source
3: illumination region
5, 6: incidence surface
7, 8, 9, 10, 11: emission surface
12, 13, 14, 15: side surface
22: illumination device
32: boundary
91: plural-wavelength light source
93: light integrator
94: tunnel mechanism
101: scattering element
150: video projection apparatus
152: display device
155: projection body
202: HMD
205: projector
209: HUD
251: smartphone
501: illumination device
502: lens
503, 504: reflector case
507: light integrator
508: plural-wavelength light source
516, 517: reflection parabolic surface

1. to 15. (canceled)

16. An illumination device comprising:
a light source; and
a light condensing body which is formed with a transparent material and is for condensing light from the light source to be emitted,
wherein the light condensing body includes an incidence surface of a light source side, an emission surface emitting light, and a side surface present between the incidence surface and the emission surface, and
the side surface is a curved surface of which a distance from a light axis in a direction orthogonal to a light emitting surface of the light source at the center of the light source becomes large from the incidence surface toward the emission surface and is configured to have a plurality of curved-surface-shapes of which shapes of the curved surfaces are different from each other,
wherein the incidence surface has two shapes in which light emitted from the light source is divided into light of an inner side which is a light axis side and light of an outer side which is away from the light axis in a direction orthogonal with respect to the light axis,
wherein the emission surface is configured to have a shape which converts an emission angle of light emitted from the light source and divided into an inner side in the incidence surface, and an outer side of shape is configured with a plurality of different shapes.

17. The illumination device according to claim 16,
wherein the plurality of curved-surface-shapes are portions of different rotating bodies, respectively, and axes of the different rotating bodies are made different.

18. The illumination device according to claim 17,
wherein the rotating bodies are ellipsoids.

19. The illumination device according to claim 18,
wherein respective axes of the rotating bodies are crossed in the light source.

20. The illumination device according to claim 19,
wherein light divided into the outer side in the incidence surface is reflected at least once in the side surface.

21. The illumination device according to claim 20,
wherein the axes of the rotating bodies pass through at least the light source and a portion between the center and an end of a targeted illumination region of the illumination device.

22. The illumination device according to claim 16,
wherein a light integrator, which homogenizes light emitted from the light source through total internal reflection and is filled with a transparent material, is disposed between the light source and the light condensing body.

23. The illumination device according to claim 22,
wherein the light integrator includes a scattering element which scatters light inside thereof.

24. The illumination device according to claim 23,
wherein the light source is a plural-wavelength light source having two or more light emitting points.

25. A video projection apparatus using the illumination device according to claim 16, comprising:
a display device that generates video; and
a projection body that projects the video generated in the display device,
wherein light from the light condensing body is illuminated on the display device.

26. The video projection apparatus according to claim 25,
wherein the projection body optically diverges video to be projected from the video projection apparatus so that a user can visually recognize a virtual image.
